(19) United States
(12) Patent Application Publication
(10) Pub. No.: US 2024/0388479 A1
(43) Pub. Date: Nov. 21, 2024

(54) METHOD AND APPARATUS OF SENDING INFORMATION BITS TO LOW POWER WAKEUP RECEIVER THROUGH MODULATED SIGNAL WITH HARMONIZED DESIGN

(71) Applicant: MEDIATEK INC., Hsin-Chu (TW)

(72) Inventors: Chien-Chun Cheng, Hsinchu City (TW); Wei-De Wu, Hsinchu City (TW); Yi-Ju Liao, Hsinchu City (TW); Yi-Chia Lo, Hsinchu City (TW)

(73) Assignee: MEDIATEK INC., Hsin-Chu (TW)

(21) Appl. No.: 18/599,215

(22) Filed: Mar. 8, 2024

Related U.S. Application Data
(60) Provisional application No. 63/502,144, filed on May 15, 2023.

(51) Int. Cl. H04L 27/06; H04L 27/26

(52) U.S. Cl. CPC H04L 27/06; H04L 27/2649

(57) ABSTRACT

A communication apparatus includes a low power wakeup receiver (LP-WUR) and a processor. The processor is configured to perform operations including: receiving a modulated signal from a network apparatus via the LP-WUR, wherein the modulated signal has a harmonized design that accommodates overlaid waveforms of one or more modulation schemes; and deriving information bits from demodulating the modulated signal.

### CROSS REFERENCE TO RELATED APPLICATIONS

This application claims the benefit of U.S. Provisional Application No. 63/502,144, filed on May 15, 2023. The content of the application is incorporated herein by reference.

### BACKGROUND

The present invention relates to wireless communications, and more particularly, to a method and apparatus of sending information bits to a low power wakeup receiver through a modulated signal with a harmonized design.

Low power wakeup signals/wakeup receivers (LP-WUS/LP-WUR) are designed for a wireless communication system with the aim of reducing power consumption and increasing energy efficiency. A wakeup signal is used to trigger the main radio (MR), and the LPWUR is an independent receiver used to monitor the signal with ultra-low power consumption. Specifically, the MR is a transceiver used for user data transmission and reception, and the LP-WUR is a simple “wake-up” receiver that does not have a transmitter. Regarding the LP-WUR, it is active while the MR is turned off, and wakes up the MR when there is a packet to receive. Regarding the MR, it is turned off unless there is something to transmit.

Typically, an On-Off Keying (OOK) modulation is adopted by a base station (e.g., gNB) for broadcasting OOK-based signals (e.g., wakeup signal and/or synchronization signal) to the LP-WUR of a user equipment (UE), decoding information bits carried by the OOK-based signal is time-consuming due to inherent characteristics of the OOK modulation. If a non-OOK modulation is adopted by the base station for broadcasting a non-OOK-based signal, the LP-WUR of the UE that only supports OOK demodulation is unable to decode information bits carried by the non-OOK-based signal.

### SUMMARY

One of the objectives of the claimed invention is to provide a method and apparatus of sending information bits to a low power wakeup receiver through a modulated signal with a harmonized design.

According to a first aspect of the present invention, an exemplary communication apparatus includes a low power wakeup receiver (LP-WUR) and a processor. The processor is configured to perform operations including: receiving a modulated signal from a network apparatus via the LP-WUR, wherein the modulated signal has a harmonized design that accommodates overlaid waveforms of one or more modulation schemes; and deriving information bits from demodulating the modulated signal.

According to a second aspect of the present invention, an exemplary communication method is disclosed. The exemplary communication method includes: receiving a modulated signal from a network apparatus via a low power wakeup receiver (LP-WUR), wherein the modulated signal has a harmonized design that accommodates overlaid waveforms of one or more modulation schemes; and deriving information bits from demodulating the modulated signal.

According to a third aspect of the present invention, an exemplary network apparatus is disclosed. The exemplary network apparatus includes a transmitter and a processor. The processor is configured to perform operations including: generating a modulated signal for a low power wakeup receiver (LP-WUR) at a communication apparatus, wherein the modulated signal has a harmonized design that accommodates overlaid waveforms of one or more modulation schemes; and sending the modulated signal to the communication apparatus via the transmitter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sequence diagram representing the procedure of how LPWUR works.

FIG. 2 is a component diagram illustrating the system components involved in the operation of an LPWUR.

FIG. 3 is a sequence diagram representing a high-level procedure for the discussed solution.

FIG. 4 is a sequence diagram illustrates the RRC Signaling aspects as interactions between the UE and gNB for implementing LP-SS RSRP in a 5G NR system.

FIG. 5 is a diagram illustrating pre-ED, post-ED combining and sequence extension.

FIG. 6 is a sequence diagram represents the signaling procedure between the UE and the gNB related to introducing new RRC signaling messages, configuring the combining method, updating L1 capability reporting, and implementing a dynamic, bi-directional signaling mechanism to share information on combining strategy performance.

FIG. 7 is a waveform diagram illustrating superposition of OOK and OFDM waveforms.

FIG. 8 is a sequence diagram illustrating the detailed signaling procedure between the gNB and UE for the hybrid approach of OOK and OFDM modulation schemes in 5G NR systems.

FIG. 9 is a sequence diagram for a procedure to support dynamic PO in the 5G NR system.

FIG. 10 is a sequence diagram for a procedure to support RRM offloading with Rel-16 RRM relaxation in the 5G NR system.

FIG. 11 is a sequence diagram illustrating the procedure of how LPWUR performs RRM offloading.

FIG. 12 is a diagram illustrating a communication system according to an embodiment of the present invention.

FIG. 13 is a flowchart illustrating operations performed by the network apparatus shown in FIG. 12 for generating and sending a modulated signal with a harmonized design according to an embodiment of the present invention.

FIG. 14 is a flowchart illustrating operations performed by the communication apparatus shown in FIG. 12 for receiving and demodulating a modulated signal with a harmonized design according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

### Issue 1: How LPWUR Works

A Low-Power Wake-Up Receiver (LPWUR) is a power-efficient subsystem designed to work alongside the main radio receiver in wireless communication devices. Its primary function is to listen for wake-up signals (LP-WUS) transmitted by the network while the main receiver remains in a low-power or sleep state, thus reducing overall power consumption. Here's a brief overview of how LPWUR works:
1. Low-power state: The main radio receiver enters a low-power or sleep state to save power when there's no active data transmission or reception needed. Meanwhile, the LPWUR remains active, continuously or intermittently monitoring incoming signals.
2. Monitoring for wake-up signals: LPWUR listens for specific wake-up signals (LP-WUS) transmitted by the network or base station. These signals could be generated using various waveforms, such as multi-carrier ASK (MC-ASK), multi-carrier FSK (MC-FSK), or CP-OFDMA. The LP-WUS can contain information such as UE-group, -subgroup, or -ID to target specific devices.
3. Synchronization: To enable the LPWUR to decode the wake-up signals, it needs to maintain synchronization with the network. This can be achieved by monitoring synchronization signals transmitted separately or as part of the LP-WUS.
4. Wake-up signal detection: When the LPWUR detects a wake-up signal intended for the device, it activates the main radio receiver, bringing it out of the low-power state. The main radio receiver then initiates data transmission or reception as required.
5. RRM measurements: In some cases, LPWUR can also be utilized to perform RRM (Radio Resource Management) measurements for serving cells, enabling power-saving benefits while in Idle or Inactive mode.

In summary, an LPWUR works by monitoring wake-up signals from the network while the main radio receiver is in a low-power state, allowing devices to save power and battery life without losing connectivity or the ability to receive incoming transmissions.

| Step | Description |
|---|---|
| 1. Low-power | The main radio receiver enters a low-power or |
| state | sleep state while LPWUR remains active for |
| | monitoring. |
| 2. Monitoring | LPWUR listens for wake-up signals (LP-WUS) |
| | transmitted by the network or base station. |
| 3. Synchronization | LPWUR maintains synchronization with the |
| | network by monitoring synchronization |
| | signals. |
| 4. Wake-up signal | LPWUR detects wake-up signals intended for the |
| detection | device and activates the main radio receiver. |
| 5. RRM measurements | LPWUR can perform RRM (Radio Resource |
| | Management) measurements for serving |
| | cells to save power. |

This table outlines the process of how LPWUR works, describing the main steps the system goes through from monitoring to waking up the main radio receiver based on incoming signals.

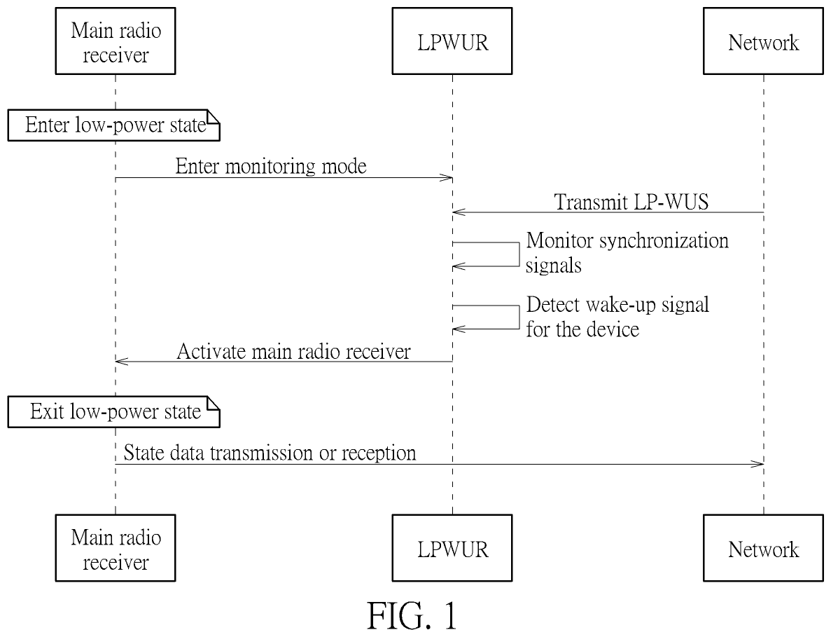

FIG. 1 is a sequence diagram representing the procedure of how LPWUR works. The sequence diagram shows the interactions between the Main Radio Receiver, LPWUR, and the Network. It also shows how the Main Radio Receiver enters a low-power state, LPWUR monitors the synchronization signals, detects wake-up signals, activates the Main Radio Receiver, and initiates data transmission or reception.

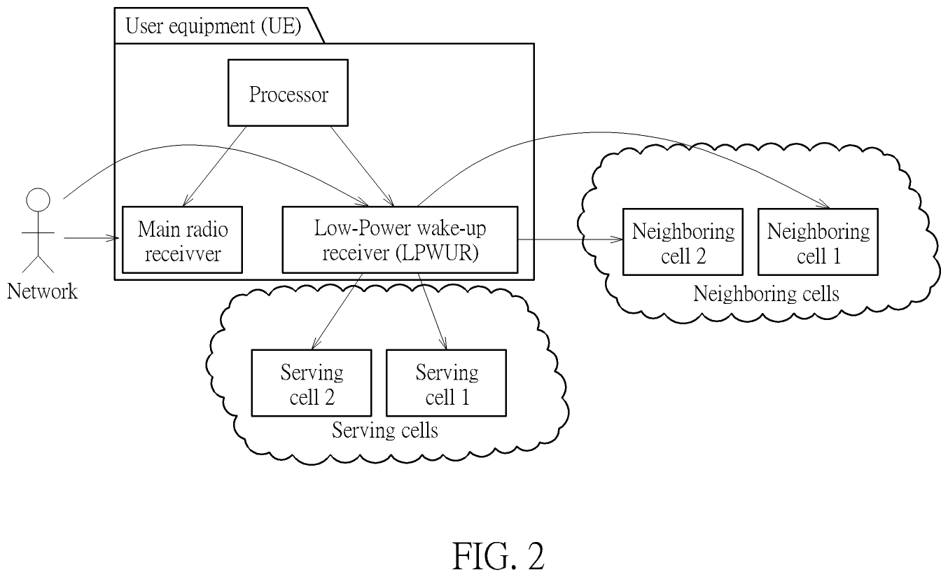

FIG. 2 is a component diagram illustrating the system components involved in the operation of an LPWUR. This diagram shows the components and interactions within the User Equipment (UE) and external entities. The Main Radio Receiver, Low-Power Wake-Up Receiver, and Processor are the primary components within the UE. The diagram also illustrates the interactions between the LPWUR, Network, and Neighboring Cells.

Please note this diagram is an abstract representation and might not depict the detailed architecture of a specific implementation.

### Issue 2: How to Support 5 MHz NR Channel

Problem: Supporting 5 MHz NR channel in some scenarios may not meet the standard. 5 MHz WUS is placed within 5 MHZ NR channel. Guardband of the NR channel is unchanged, how many additional guardgap is needed. The challenge is to efficiently design and deploy a 5 MHz NR channel to accommodate devices and use cases that require lower bandwidth configurations while maintaining compatibility with existing 5G standards.

Solution: When considering that the UE needs to be aware of the guard band and the NR channel bandwidth, the following approaches can be implemented to ensure efficient communication and spectrum utilization:

### Scenario 1: When the NR Channel is 5 MHZ

1. Signaling and Configuration: Include necessary signaling information in the system information or RRC signaling messages, allowing the UE to determine the channel bandwidth and guard band configuration for the 5 MHz NR channel.
2. Adaptive Channel Estimation and Equalization: Implement adaptive channel estimation and equalization techniques at the UE to compensate for the specific guard band and channel bandwidth characteristics, improving link performance in a 5 MHZ NR channel.
3. Synchronization and Cell Search: Design efficient synchronization and cell search procedures for the UE to reliably detect and acquire the 5 MHz NR channel, taking into account the different guard band and channel bandwidth conditions.
   Scenario 2: When the NR Channel is Wider than 5 MHz
1. Signaling and Configuration: Similar to Scenario 1, provide the UE with the necessary signaling information in the system information or RRC signaling messages, allowing the UE to determine the channel bandwidth and guard band configuration for the wider NR channel.
2. Radio Resource Management (RRM): Implement effective RRM strategies, such as resource allocation, power control, and handover, to help the UE adapt to different guard band configurations and channel bandwidth conditions.
3. Carrier Aggregation (CA) Configuration: When employing carrier aggregation, ensure that the UE is informed about the guard band and channel bandwidth configurations for each aggregated carrier, allowing the UE to adapt its communication accordingly and maximize performance.
4. Flexible Receiver Design: Implement a flexible receiver design to support variable guard band and channel bandwidth conditions, enabling the UE to adapt to different network configurations while maintaining link quality and performance.

By incorporating these approaches, efficient communication can be achieved in both 5 MHz and wider NR channels, enabling the UE to be aware of the guard band and channel bandwidth, and adapt its operation accordingly.

When considering that the UE should be able to report whether the 5 MHz NR channel can be supported or not, the following aspects should be addressed:
1. UE Capability Information: Extend the UE capability information message to include a field indicating if the UE supports the 5 MHz NR channel. The UE will report its capabilities, including the supported channel bandwidths, during the initial registration or when requested by the network.
2. Network Configuration and Policy: Based on the UE reported capabilities, the network can configure the necessary resources for the UE, taking into account whether the UE can support the 5 MHz NR channel. The network can adapt its policies for resource allocation and assignment, handovers, and other radio resource management actions accordingly.
3. Handover and Redirection Procedures: Include the relevant information regarding the UE's support for 5 MHz NR channel in handover and redirection procedures, allowing for more informed decision-making when considering different cells and frequencies during mobility events.
4. UE Measurements: Adapt the UE measurement configuration to consider the UE's support for 5 MHZ NR channel. Incorporate the supported bandwidth information in the measurement reports sent by the UE, enabling the network to make better-informed decisions for resource allocation, handover, and other mobility-related actions.
5. Support for Carrier Aggregation (CA): If the UE supports carrier aggregation, include information regarding the support for the 5 MHz NR channel when aggregating carriers. This will ensure compatibility with the overall system and lead to efficient use of resources for the UE with different channel bandwidths.

By incorporating these elements, the UE can effectively report whether the 5 MHz NR channel is supported or not, enabling the network to configure resources and apply management policies accordingly.

Considering that the UE should have different behavior based on whether the LP-WUS is on a 5 MHz NR channel, the following approaches can be implemented:
1. Detection and Synchronization: Design efficient detection and synchronization procedures for UE to reliably detect and acquire LP-WUS signals, taking into account whether the LP-WUS is on a 5 MHZ NR channel or on a wider channel. Adapt the UE search strategy accordingly to optimize searching and synchronization processes.
2. LP-WUS Decoding and Operation: Implement adaptive decoding techniques for the UE to process LP-WUS signals based on the channel bandwidth. This includes adjusting the demodulation and decoding parameters and thresholds based on whether the LP-WUS is on a 5 MHZ NR channel for optimal performance.
3. Power Saving and Wake-up Patterns: Modify the UE's power-saving behavior and wake-up patterns based on the channel bandwidth in which the LP-WUS is operating. For a 5 MHZ NR channel, the UE may require different duration and frequency of wake-up opportunities compared to wider channels to ensure effective communication and battery life optimization.
4. RRM Measurements and Reporting: Adapt the UE's radio resource management (RRM) measurements and reporting based on the channel bandwidth of LP-WUS. The configuration of RRM measurements, such as measurement periods, filtering, and reporting criteria, may differ depending on whether the LP-WUS is operating within a 5 MHZ NR channel.
5. Handover and Mobility Management: Tailor the UE's handover and mobility management strategies based on the LP-WUS channel bandwidth. For instance, adjust handover thresholds, target cell selection, and measurement configuration while taking into account the 5 MHz NR channel support for LP-WUS, ensuring smooth and optimized UE mobility.

By incorporating these adaptations in the UE, different behavior can be achieved when the LP-WUS is on a 5 MHz NR channel, resulting in optimal performance, improved power-saving, and effective mobility management.

Considering the guard band when the NR channel is 5 MHz and when it is wider than 5 MHz, we can create a detailed solution based on these two scenarios:

### Scenario 1: When the NR Channel is 5 MHz

1. In-channel Guard Band: For a 5 MHz NR channel, utilize a smaller in-channel guard band to maintain separation between neighboring channels while maximizing the efficient use of the limited bandwidth. Ensure this smaller guard band still meets the minimum requirements defined in the 5G NR specifications.
2. Adaptive Resource Allocation: Allocate resource blocks dynamically to adjust the spacing between the active channels, allowing for more efficient use of the 5 MHz NR channel while maintaining a defined amount of guard band protection.
3. Interference Management: Implement advanced interference cancellation and suppression techniques to mitigate the impact of any potential interference from nearby channels caused by the smaller guard bands.
   Scenario 2: When the NR Channel is Wider than 5 MHz
1. Larger In-channel Guard Band: Utilize a larger in-channel guard band for wider NR channels to ensure adequate separation between neighboring channels and reduce adjacent-channel interference.
2. Fractional Frequency Reuse (FFR): Implement FFR techniques in the system to allocate different frequency resources to adjacent cells, minimizing co-channel and adjacent-channel interference while maintaining the required guard bands between the channels.
3. Carrier Aggregation (CA): Leverage carrier aggregation to combine multiple carriers, including those with different guard bands, to increase the overall channel bandwidth and data rate in the system while maintaining proper channel separation.
4. Dynamic Spectrum Sharing (DSS): Employ dynamic spectrum sharing techniques to more efficiently utilize the available spectrum with varying guard band requirements, enabling simultaneous support for devices and applications with different bandwidth constraints.

By considering these guard band-related approaches for both scenarios, a balance between efficient spectrum utilization and protection against interference can be achieved for 5 MHz and wider NR channels while maintaining compatibility with the 5G NR standards.

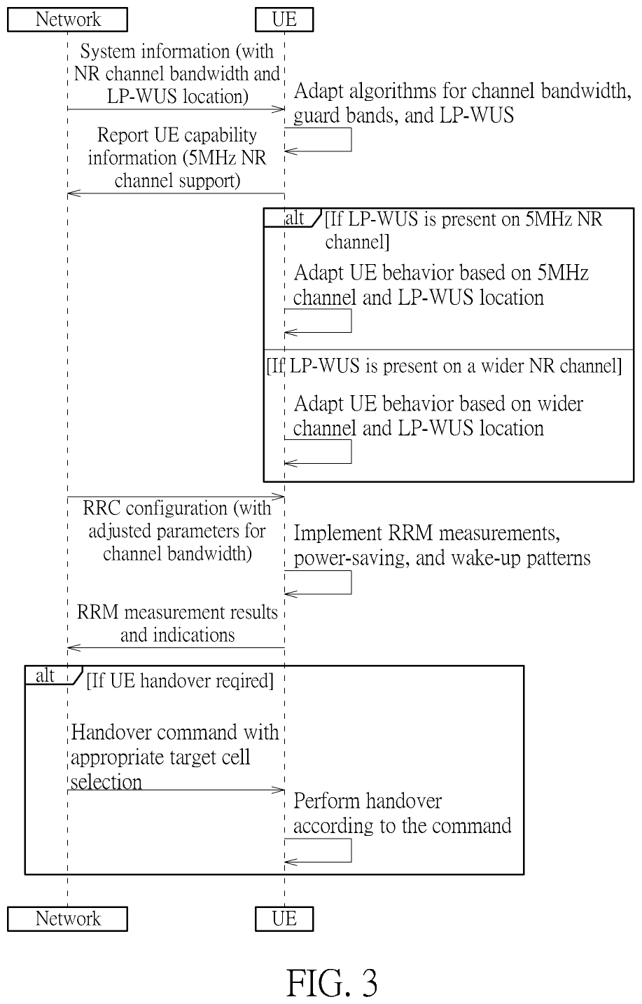

FIG. 3 is a sequence diagram representing a high-level procedure for the discussed solution. This sequence diagram illustrates the interaction between the network and the UE while considering the discussed solution. It shows the configuration, capability reporting, adjustments based on channel bandwidth and LP-WUS, and potential handover if required.

| | Impact | Analysis and |
|---|---|---|
| Standard module | (Y/N) | spec changes |
| Frame Structure | N | The new feature doesn't affect the |
| | | frame structure. |
| SCS & CP, Modulation | Y | Requires revamping of modulation |
| | | for adaptive performance in |
| | | varying guard band scenarios. |
| Sequence Generation | N | No impact on sequence generation. |
| Initial access SS/PBCH | Y | Design improved synchronization |
| | | and cell search procedures to |
| | | handle different guard bands. |
| Paging | N | No impact on paging. |
| PRACH (incl. RACH | N | No impact on PRACH. |
| procedure) | | |
| RRM | Y | Implement RRM strategies with |
| | | guard band and channel bandwidth |
| | | considerations. |
| RLM | N | No impact on RLM. |
| DL MIMO (incl. Tx | N | No impact on DL MIMO. |
| schemes, CSI-RS & | | |
| related procedure) | | |
| UL MIMO (incl. Tx | N | No impact on UL MIMO. |
| schemes, SRS & | | |
| related procedure) | | |
| Beam Management, | N | No impact on beam management. |
| QCL & SYNC (incl. | | |
| TA, TRS, PTRS ) | | |
| PRS (incl. procedure) | N | No impact on PRS. |
| PDCCH (incl. DMRS, | Y | Update signaling and |
| DCI formats, | | configuration to include guard |
| Rx procedure) | | band and channel bandwidth |
| | | information. |
| Channel Coding | N | No impact on channel coding. |
| PDSCH (incl. DMRS, | N | No impact on PDSCH. |
| Rx procedure) | | |
| PUCCH (incl. DMRS, | N | No impact on PUCCH. |
| UCI multiplexing, | | |
| Tx procedure) | | |
| PUSCH (incl. DMRS, | N | No impact on PUSCH. |
| Tx procedure) | | |
| DL HARQ (incl. | N | No impact on DL HARQ. |
| HARQ-ACK) | | |
| PDSCH UE | N | No impact on PDSCH UE |
| Processing Time | | processing time. |
| PUSCH UE | N | No impact on PUSCH UE |
| Processing Time | | processing time. |
| BWP-specific | N | No impact on BWP-specific aspects. |
| SUL-specific | N | No impact on SUL-specific aspects. |
| CA-specific | Y | Adjust CA configurations to |
| | | support different guard band and |
| | | channel bandwidth scenarios. |
| MRDC-specific | N | No impact on MRDC-specific |
| | | aspects. |
| UL Power Control | N | No impact on UL power control. |
| DL Channel Access | N | No impact on DL channel access. |
| UL Channel Access | N | No impact on UL channel access. |
| L1 Capability | Y | Extend UE capability information |
| | | to report support for 5 MHz NR |
| | | channel. |

The table illustrates the impact and proposed changes on various 5G NR standard modules for the new feature involving UE awareness of the guard band and channel bandwidth, considering different scenarios. This evaluation can guide necessary changes and design improvements in specific modules to accommodate the new feature effectively.

Here is a detailed breakdown of the procedure changes for the impacted modules to accommodate the new feature:

### 1. SCS & CP, Modulation:

Update the modulation schemes used by the UE based on the channel bandwidth and guard band configuration to balance spectral efficiency and link reliability.
Define guard band-aware thresholds for modulation and coding scheme (MCS) selection as part of the link adaptation process.

### 2. Initial Access SS/PBCH:

Modify the synchronization signal (SS) and physical broadcast channel (PBCH) transmission parameters based on guard band and NR channel bandwidth configuration.
Adjust SS/PBCH resource mapping, transmitted power, and signal structure to compensate for varying channel bandwidth and guard band conditions.

### 3. RRM:

Implement dynamic resource allocation and measurement configuration based on the different guard band and channel bandwidth conditions.
Adjust handover thresholds, target cell selection, and RRM measurement configuration to take into account the different guard band, channel bandwidth, and LP-WUS information.
   4. PDCCH (Incl. DMRS, DCI Formats, Rx Procedure):
Update PDCCH DCI formats and signaling to include the necessary guard band and channel bandwidth information.
Adapt the PDCCH reception and decoding process based on the received guard band and channel bandwidth information.

### 5. CA-Specific:

Modify carrier aggregation (CA) configurations to support different guard band and channel bandwidth scenarios.
Communicate aggregated carrier guard band and channel bandwidth configurations to the UE effectively.

### 6. L1 Capability:

Extend UE L1 capability reporting to include supported channel bandwidths, specifically the support for a 5 MHz NR channel.
Utilize this capability information to adapt the network configuration, resource allocation, and handover decisions accordingly.

### 7. Channel State Information (CSI) Reporting:

Augment the CSI reporting procedures to include guard band and NR channel bandwidth information.
Utilize the reported CSI information to perform better link adaptation according to specific guard band and channel bandwidth scenarios.

### 8. Interference Management:

Implement improved interference management techniques to minimize interference caused by different guard bands.
Adapt interference cancellation algorithms and receiver designs based on different guard band and channel bandwidth configurations.

### 9. Quality of Service (Qos):

Update Qos parameters and handling strategies based on channel bandwidth and guard band-aware UEs.
Adjust scheduling, admission control, and bearer management policies considering guard band and channel bandwidth scenarios.

### 10. Discontinuous Reception (DRX):

Revise the DRX configuration and operation based on guard band and channel bandwidth variations.
Calibrate DRX inactivity timers and wake-up patterns to adapt to specific channel bandwidth and guard band scenarios.

### 11. Wake-Up Signal (WUS):

Update WUS transmission and reception practices based on varying guard band and channel bandwidth conditions.
Configure wake-up opportunities for UEs by considering the difference in guard bands and NR channel bandwidths.

### 12. Multi-RAT Coordination:

Enhance Multi-RAT coordination strategies by incorporating guard band and channel bandwidth information.
Allocate resources across multi-RAT technologies while ensuring minimal inter-RAT interference in varying guard band scenarios.

### 13. Dynamic Spectrum Sharing (DSS):

Improve DSS techniques by considering guard band and channel bandwidth variations.
Design DSS resource allocation policies that efficiently utilize the spectrum with different channel bandwidths and guard band configurations.

### 14. Dual Connectivity (DC) and Carrier Aggregation:

Adapt dual connectivity and carrier aggregation configurations based on the guard band and channel bandwidth settings.
Define unique dual connectivity strategies for combinations of overlapping guard band and channel bandwidth scenarios.

### 15. Network Slicing:

Implement network slicing strategies tailored to varying guard band and channel bandwidth cases.

Allocate resources and services for individual network slices with a guard band and channel bandwidth-aware approach.

By applying these detailed procedure changes across the impacted modules, the 5G NR standard can effectively accommodate the new feature involving UE awareness of the guard band and channel bandwidth, resulting in optimized performance across various scenarios.

### Issue 3: How to Support LP RSRP

Problem: Implementing LP-SS RSRP in a 5G NR system faces challenges, including longer periodicity affecting mobility and power consumption, lower measurement quality impacting resource allocation and handovers, handling partial SS/PBCH block (OOK or PSS-only) in UE algorithms and signaling, increased system complexity, heightened interference management concerns due to low power signals, link budget analyses for coverage, coordination difficulties in dual connectivity and multi-RAT scenarios, accurate timing synchronization issues, and ensuring backward compatibility. Addressing these challenges is crucial for leveraging LP-SS RSRP in enhancing coverage, synchronization, and power-saving techniques in low power scenarios.

solution: To overcome the challenges associated with implementing LP-SS RSRP, the following solutions should be put in place, organized according to the UE, gNB, and signaling aspects.

### UE Behavior:

1. Update UE measurement algorithms to decode and accurately measure LP-SS RSRP, taking into account the lower power signals, OOK modulation, and/or PSS-only structure.
2. Schedule and allocate appropriate resources for measurement gaps or longer tracking periods to accommodate the longer periodicity of LP-SS.
3. Implement filtering, averaging, or smoothing techniques on the LP-SS RSRP measurements to enhance the reported RSRP accuracy and reduce measurement uncertainty.
4. Adapt handover thresholds and target cell selection, as well as power-saving and wake-up strategies based on the LP-SS RSRP measurements and performance.
5. Update the receiver design to handle interference more effectively, accommodating the properties of the LP-SS and preserving decision-making quality.

### gNB Behavior:

1. Transmit LP-SS with appropriate transmission power adjustment, timing considering the low power nature and synchronization requirements for the device.
2. Adapt radio resource management strategies, such as resource allocation, power control, and handover, to account for the different properties of LP-SS RSRP.
3. Allocate appropriate resources for LP-SS in terms of frequency, bandwidth, and transmission power, ensuring efficient operation and minimized interference.
4. Coordinate with other gNBs or multi-RAT systems in terms of resource allocation, interference management, and handover decisions based on LP-SS RSRP measurements.

### Signaling:

1. Introduce RRC signaling messages and configuration to support LP-SS RSRP, including the necessary system information, measurement gaps, cell reselection, and handover commands.
2. Update L1 capability reporting to include support for LP-SS RSRP and its properties, such as OOK modulation or PSS-only structure.
3. If applicable, provide higher-layer configurations specifying when to use LP-SS RSRP and how to utilize LP-SS measurements for decision-making purposes.
4. Implement signaling mechanisms for the gNB to adjust LP-SS scheduling and transmission resources based on real-time network conditions and UE demand.

### Solution Highlights:

Add a new component in the UE behavior: “LPWUS Handling & Decoding”. This component is responsible for handling, decoding, and interpreting LPWUS messages carrying missing information that the UE cannot obtain from partial SS/PBCH blocks.

Add a new component in the gNB behavior: “LPWUS Transmission”. This component is responsible for scheduling and transmitting LPWUS containing the missing information for UEs limited to PSS or SSS monitoring.

By leveraging LPWUS to carry the missing information when the UE cannot monitor the full SS/PBCH block, the overall implementation complexity can be reduced. The use of LPWUS offers an efficient way to support LP-SS RSRP and ensure effective synchronization and power management in low power scenarios.

Below is the filled table evaluating the impact of the new feature on the different 5G NR standard modules:

| | Impact | | Impact |
|---|---|---|---|
| Standard module | (Y/N) | Standard module | (Y/N) |
| Frame Structure | N | PDSCH (incl. DMRS, Rx | N |
| | | procedure) | |
| SCS & CP, Modulation | Y | PUCCH (incl. DMRS, UCI | N |
| | | multiplexing, Tx | |
| | | procedure) | |
| Sequence Generation | Y | PUSCH (incl. DMRS, Tx | N |
| | | procedure) | |
| Initial access SS/PBCH | Y | DL HARQ (incl. HARQ-ACK) | N |
| Paging | N | PDSCH UE Processing Time | N |
| PRACH (incl. RACH | N | PUSCH UE Processing Time | N |
| procedure) | | | |
| RRM | Y | BWP-specific | N |
| RLM | N | SUL-specific | N |
| DL MIMO (incl. Tx | N | CA-specific | N |
| schemes, CSI-RS & | | | |
| related procedure) | | | |
| UL MIMO (incl. Tx | N | MRDC-specific | N |
| schemes, SRS & | | | |
| related procedure) | | | |
| Beam Management, | Y | UL Power Control | N |
| QCL & SYNC (incl. | | | |
| TA, TRS, PTRS) | | | |
| PRS (incl. procedure) | N | DL Channel Access | N |
| PDCCH (incl. DMRS, DCI | N | UL Channel Access | N |
| formats, Rx procedure) | | | |
| Channel Coding | N | L1 Capability | Y |

### Analysis & Examples

SCS & CP, Modulation: As the LP-SS is based on OOK or PSS, the modulation schemes must be updated to accommodate the new feature. Example: Handle On-Off Keying modulation in UE measurement algorithms.

Sequence Generation: Since the LP-SS uses a partial SS/PBCH block and may have a longer periodicity, sequence generation needs to consider these factors. Example: Adjust Zadoff-Chu sequences or M-sequence generation, taking into account the PSS-only or OOK schemes.

Initial access SS/PBCH: The LP-SS is a partial SS/PBCH block, so it requires changes in the SS/PBCH decoding and measurement algorithms. Example: Updates to synchronization signal decoding to support PSS or SSS only.

RRM: The radio resource management strategies must be adapted to account for the new feature, impacting measurements, reporting, and scheduling. Example: Update measurement configurations and thresholds for LP-SS RSRP.

Beam Management: Beam management may need adjustments for synchronization as LP-SS are lower power signals. Example: Adapt beamforming methods to synchronize with lower power synchronization signals.

L1 Capability: Update L1 capability reporting to provide information about the UE's support for handling LP-SS RSRP and its properties. Example: Indicate the support for OOK modulation or PSS-only structure in L1 capability reporting messages.

Based on the proposed solution for implementing LP-SS RSRP in 5G NR systems, additional updates to certain standard modules are as follows:

### Signaling:

1. RRC Signaling: Introduce new RRC signaling messages and configurations to support the LP-SS RSRP. This may include defining new information elements, which indicate the LP-SS RSRP specific parameters, measurement gap configurations, cell reselection, and handover commands affecting the UE and gNB behavior. For example, adding an Ip-ssMeasurementConfig field in the MeasObject structure for the RRC Connection Reconfiguration message.
2. MAC Layer Signaling: If required, update the MAC layer signaling to provide feedback regarding the LP-SS RSRP measurements, buffer status, or scheduling requests relevant to the LP-SS RSRP scenario. For example, modifying the MAC PDU format to carry the information related to the LP-SS RSRP measurements upon request.
3. NL-SAP Signaling: Enhance the Network Layer Service Access Point (NL-SAP) interface to handle the signaling changes and cross-layer communication introduced because of the LP-SS RSRP. This may include updates to messages and procedures related to resources, measurement, and link adaptation. For example, extending MeasReport messages to include LP-SS RSRP measurement results.

### Resource Allocation:

1. PDCP Layer Changes: If required, update the PDCP layer of the UE and gNB to efficiently handle data transmission and retransmission, considering the modified reception conditions under the LP-SS RSRP scheme. For example, optimizing header compression methods or ROHC profiles suitable for LP-SS RSRP scenarios.
2. Scheduler Changes: To accommodate the LP-SS RSRP, both the UL and DL schedulers at the gNB must be updated. This ensures optimal resource allocation considering the unique characteristics of LP-SS RSRP, potentially impacting critical KPIS such as latency, throughput, and fairness. For example, creating scheduler policies that prioritize UEs operating under LP-SS RSRP conditions to maintain synchronization and minimize performance degradation.

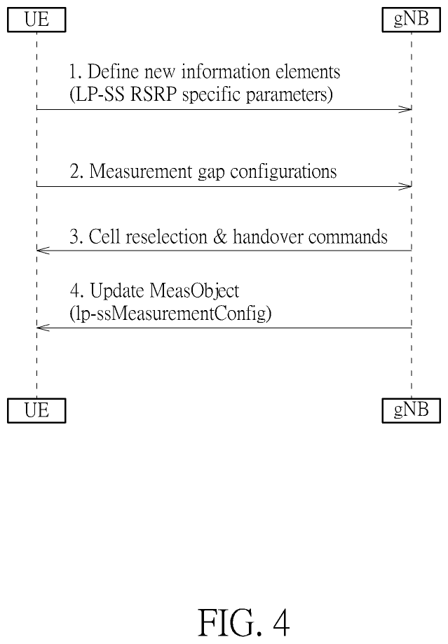

These updates complement the previously discussed changes and further strengthen the system's capabilities to effectively support and efficiently implement the LP-SS RSRP feature. As a result, improvements in coverage, synchronization, and power-saving techniques in low power scenarios can be achieved. FIG. 4 is a sequence diagram illustrates the RRC Signaling aspects as interactions between the UE and gNB for implementing LP-SS RSRP in a 5G NR system.

### Issue 4: How to Support Combining

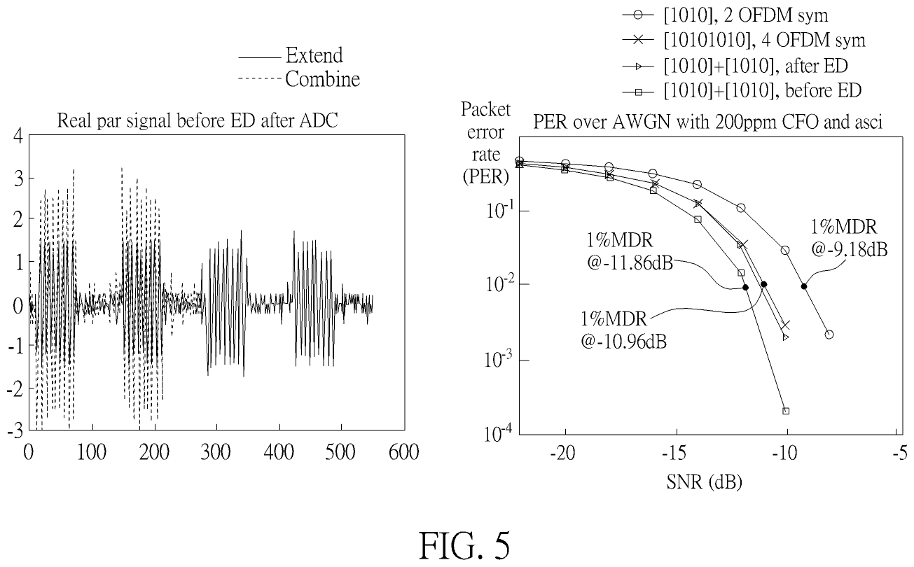

Problem: In 5G NR systems, Low Power Wake-up Receivers (LPWUR) require a different combining strategy to minimize performance losses due to the coverage gap between the main radio and LPWUR. Coherent and non-coherent combining methods have distinct requirements and performance gains. For instance, if the gNB generates OOK signals using a random sequence or phase, the UE cannot perform coherent combining before envelope detection (ED), resulting in a 3 dB loss when the signal doubles. There must be a common strategy established between the UE and gNB that takes into account timing and frequency resources to maximize combining gain. Repetitions of short OOK signals prove more effective for coverage enhancement, allowing UE to combine before envelope detection, which better averages out noise samples and optimizes gains in the presence of frequency errors. FIG. 5 is a diagram illustrating pre-ED, post-ED combining and sequence extension.

Solution: To address the problem of combining strategies for LPWUR in 5G NR systems, we propose the following detailed solutions categorized into UE behavior, gNB behavior, and signaling between UE and gNB.

### UE Behavior:

1. Implement coherent and non-coherent combining options in the UE's receiver design, enabling it to adapt based on the configuration provided by the gNB.
2. Periodically synchronize timing and frequency with the gNB to maintain low uncertainty, allowing for more effective pre-envelope detection (pre-ED) combining, even in scenarios with frequency errors.
3. Determine the optimal combining method based on the received configuration and the specific OOK signal properties (such as short or long OOK signals) to maximize the combining gain and coverage enhancement.

### gNB Behavior:

1. Ensure the gNB uses fixed sequences or phase alignments for generating OOK signals to facilitate coherent combining for UEs before envelope detection, minimizing losses.
2. Adapt transmission strategies based on the UE's individual ability to handle coherent or non-coherent combining methods, leveraging higher-layer configurations or signaling messages to gather this information.
3. Monitor the performance of the combining strategies used by UEs to optimize resource allocation and transmission parameters, considering factors such as interference, power adjustment, and overall network capacity.

### Signaling Between UE and gNB:

1. Introduce new RRC signaling messages and configurations that enable the gNB to configure the combining method for UEs, including information on the specific time and frequency resources for combining.
2. Update L1 capability reporting by the UE, including information about its support for coherent or non-coherent combining and any constraints or preferences related to its LPWUR.
3. Implement a dynamic, bi-directional signaling mechanism that allows the gNB and UE to share information on combining strategy performance, adapting to real-time network conditions and UE requirements.

By adopting these solutions, the 5G NR system can effectively manage the coverage gap between the main radio and LPWUR, maximizing the combining gain and coverage enhancement under various signal and network conditions. This approach facilitates efficient resource allocation and improves the overall system performance by relying on a shared understanding of combining strategies between the UE and gNB.

### Solution

The proposed solution to improve the coverage performance is to adopt coherent combining techniques in the receiver for different LPWUS modulation schemes, such as OOK, SSS, and PDCCH:

Selection of combining method: Employ coherent combining as it takes into account both the amplitude and phase of the incoming signals, resulting in better coverage performance compared to non-coherent combining methods.
1. Coherent combining implementation: Implement coherent combining in the receiver by aligning the phase of the incoming signals and summing them together. This technique exploits the phase information to enhance the signal strength while canceling out the noise and interference.
2. Resource optimization: Optimize resource usage by adapting the LPWUS signal structure (consisting of OFDM symbols and resource blocks) and the corresponding transmission parameters (such as the number of repetitions, subcarrier spacing, and noise figure) based on the signal type, focusing on achieving a desirable minimum indicator level (MIL).
3. Sequencing and modulation: Experiment with different LPWUS sequences (OOK, SSS, PDCCH) and modulations (OOK-4, MC-ASK, MC-FSK) to determine their respective coverage capabilities and potential gains under coherent combining conditions. This will help to select the most suitable sequence and modulation schemes for various deployment scenarios and requirements.

By implementing these adjustments, the solution aims to strike a balance between coverage performance, resource allocation, and power efficiency for LPWUS modulation schemes in a low-power wide-area network environment.

### Argument

Different sequences, such as OOK, SSS, and PDCCH, have varying coverage performance characteristics. With coherent combining, the MIL values improve for OOK-based LPWUS signals. For example, by employing 16 OFDM symbols with coherent combining, an OOK LPWUS can achieve the PUSCH Msg3 MIL. This improvement demonstrates the potential benefits of utilizing coherent combining techniques in coverage enhancement.

### Spec Impact

To implement this solution, RANI specifications need to be updated to take into account the coherent combining techniques, resource allocation, and power efficiency concerns. The spec modifications should strive to achieve the average Msg3 MIL using repetitions with coherent combining. By doing so, RANI can reduce network resource overhead and enable better coverage performance in a low-power wide-area system. This update will be crucial for the development and optimization of LPWAS systems utilizing LPWUS with different modulation schemes, ultimately contributing to better overall coverage performance.

Here's the filled table evaluating the impact of the new feature on the different 5G NR standard modules:

| | Impact | | Impact |
|---|---|---|---|
| Standard module | (Y/N) | Standard module | (Y/N) |
| Frame Structure | N | PDSCH (incl. DMRS, Rx | N |
| | | procedure) | |
| SCS & CP, Modulation | Y | PUCCH (incl. DMRS, UCI | N |
| | | multiplexing, Tx | |
| | | procedure) | |
| Sequence Generation | N | PUSCH (incl. DMRS, Tx | N |
| | | procedure) | |
| Initial access SS/PBCH | N | DL HARQ (incl. HARQ-ACK) | N |
| Paging | N | PDSCH UE Processing Time | N |
| PRACH (incl. RACH | N | PUSCH UE Processing Time | N |
| procedure) | | | |
| RRM | Y | BWP-specific | N |
| RLM | N | SUL-specific | N |
| DL MIMO (incl. Tx | N | CA-specific | N |
| schemes, CSI-RS & | | | |
| related procedure) | | | |
| UL MIMO (incl. Tx | N | MRDC-specific | N |
| schemes, SRS & | | | |
| related procedure) | | | |
| Beam Management, | N | UL Power Control | N |
| QCL & SYNC (incl. | | | |
| TA, TRS, PTRS) | | | |
| PRS (incl. procedure) | N | DL Channel Access | N |
| PDCCH (incl. DMRS, DCI | Y | UL Channel Access | Y |
| formats, Rx procedure) | | | |
| Channel Coding | N | L1 Capability | Y |

### Analysis & Examples

SCS & CP, Modulation: As the LPWUR considers simple hardware, modulation schemes must be adapted to accommodate the new feature, such as coherent and non-coherent combining. Example: Update modulation schemes in UE's receiver design to adapt based on the provided configuration.

RRM: The radio resource management strategies must be adapted to account for the new feature; this includes monitoring the performance of combining strategies, optimizing resource allocation, and transmission parameters. Example: Update RRM algorithms to consider the individual ability to handle coherent or non-coherent combining methods.

PDCCH (incl. DMRS, DCI formats, Rx procedure): New RRC signaling messages and configurations are necessary to enable the gNB to configure the combining method for UEs, including information on the specific time and frequency resources for combining. Example: Add new DCI formats to signal combining information to the UE.

UL Channel Access: Changes to the UL channel access procedure to account for the dynamic bi-directional signaling mechanism that allows sharing information on combining strategy performance. Example: Introduce new UL grant allocation for facilitating the signaling of combining strategy performance.

L1 Capability: Update L1 capability reporting to provide information about the UE's support for handling coherent or non-coherent combining and any constraints or preferences related to its LPWUR. Example: Add new fields to the L1 capability report message to indicate support for the proposed combining strategies.

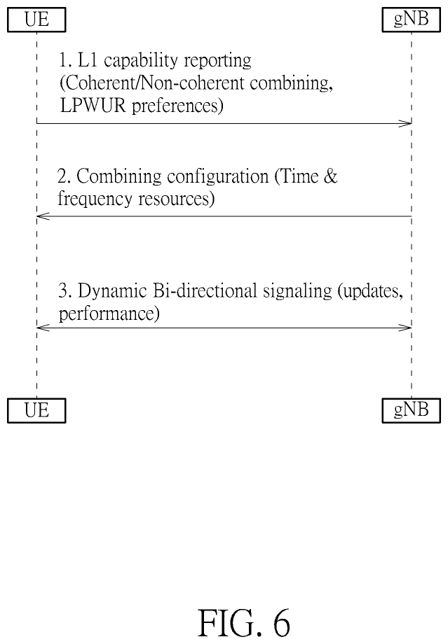

FIG. 6 is a sequence diagram represents the signaling procedure between the UE and the gNB related to introducing new RRC signaling messages, configuring the combining method, updating L1 capability reporting, and implementing a dynamic, bi-directional signaling mechanism to share information on combining strategy performance. The diagram illustrates the flow of information between the UE and gNB and the key steps in the procedure.

### Issue 5: How to Support Waveform Superpositions

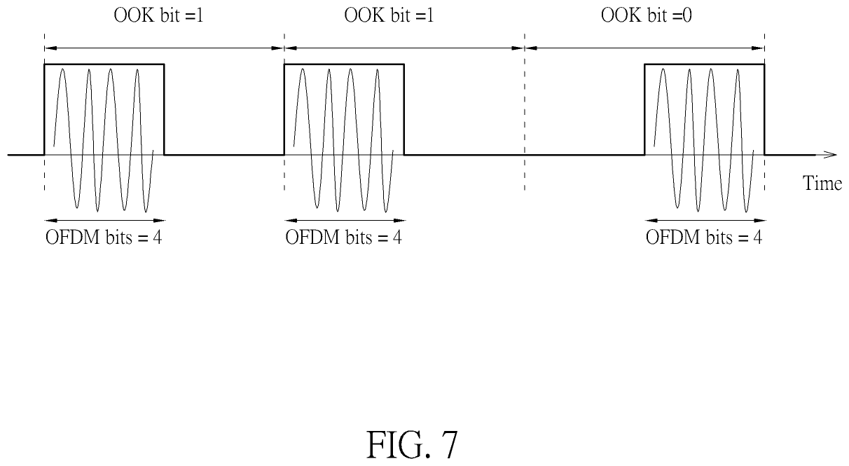

Problem: In 5G NR systems, utilizing a unified design to accommodate different low power wake-up signals (LPWUS) and various low power wake-up receivers (LPWUR) is essential for flexible communication. Combining OOK and OFDM modulation schemes in such design allows UEs to detect different levels of information based on their capabilities. For instance, UEs detecting OOK alone can identify the group ID, whereas those capable of detecting OFDMA or other waveforms within OOK can extract additional information like subgroup IDs or cell information. This hybrid approach enhances spectral efficiency and adapts to diverse data rates and coverage scenarios. FIG. 7 is a waveform diagram illustrating superposition of OOK and OFDM waveforms.

Solution: To leverage the benefits of OOK and OFDM modulation schemes in 5G NR systems, the following detailed solutions are proposed:
1. Enhance the PDCCH/SSS design: Update the PDCCH/SSS design to allow transmission of OOK with a one-bit group ID, which can be detected within a given number of monitoring occasions. This ensures a minimum level of paging functionality for UEs that can only detect OOK, providing basic coverage.
2. Superimpose OFDMA signals on OOK signals: Design the transmitted PDCCH/SSS to include a section that contains an additional two bits of information using OFDMA or other waveforms. This will allow UEs capable of detecting OFDMA to receive more information within the same monitoring occasions.
3. UE-side adaptation: Adapt the UE's receiver design to detect and process the appropriate signal based on its capabilities. If only OOK detection is possible, the UE should be able to process the one-bit subgroup ID (R17 design) and receive paging with a one-bit subgrouping resolution. Conversely, if the UE can detect and decode OFDMA or additional waveforms, it should process the additional two bits of information embedded in the transmitted PDCCH/SSS, allowing it to receive the whole subgroup ID (R17 design) and facilitate subgroup paging functionality.
4. Dynamic signaling between the gNB and UE: Implement a signaling mechanism between the gNB and UE to exchange information about the UE's capabilities and preferences. This information assists the gNB in configuring the PDCCH/SSS transmissions adaptively, ensuring optimal communication among UEs with varying capabilities.

By implementing these solutions, the 5G NR system benefits from a hybrid approach that combines the advantages of OOK and OFDM modulation schemes. This will lead to enhanced spectral efficiency, flexible paging functionality, and improved coverage across different scenarios and UE capabilities.

Here are more detailed solutions for the UE behavior, gNB behavior, and signaling between UE and gNB while implementing the hybrid approach for OOK and OFDM modulation schemes in 5G NR systems: UE Behavior:
1. Implement an adaptive receiver design in the UE that can detect both OOK signals (for one-bit subgroup ID) and OFDMA signals (for the additional two bits) based on the UE's capabilities.
2. Ensure the UE is capable of processing and combining received information from OOK and OFDMA signals to reconstruct the full subgroup ID (R17 design), only if it has appropriate capabilities and preferences.
3. Report the UE's capabilities and preferences to the gNB during the initial access or periodic updates, allowing the gNB to adapt its transmission strategies accordingly.

### gNB Behavior:

1. Adapt the PDCCH/SSS design in the gNB to incorporate the OOK modulation for one-bit information and a section containing OFDMA or other waveforms for the additional two bits of information, ensuring the transmission works for all UEs with varying capabilities.
2. Optimize the gNB's resource allocation and transmission strategies based on individual UE capabilities, which include the UE's ability to detect and process OOK and/or OFDMA signals regarding the subgroup ID (R17 design).
3. Continuously monitor and assess the performance of the mixed-modulation schemes on different UE devices to refine the transmission parameters, such as power allocation and interference management.

### Signaling Between UE and gNB:

1. Introduce new messages and configurations in the RRC signaling protocol that enable the gNB and UE to exchange information about their capabilities in detecting and processing OOK and OFDMA signals. For example, the UE can report its ability to process one-bit subgroup ID or a combination of one-bit and two-bit information.
2. Implement procedures for dynamic adaptation and refinement of the signaling and configuration. This allows gNB and UE to continuously update their communication based on real-time network conditions and UE requirements.
3. Include a fallback mechanism in the signaling protocol to handle cases when the UE is unable to decode the additional two bits of information from OFDMA or other waveforms, thereby ensuring basic communication and coverage through OOK signals.

By adopting these detailed solutions, the 5G NR system can effectively balance the benefits of both OOK and OFDM modulation schemes, enhancing the overall system performance by satisfying diverse communication demands while ensuring optimal resource allocation and coverage.

### Solution

To effectively address the preference of waveform issue while accommodating different types of LPWUS and various LPWUR designs, a two-fold approach is proposed:
1. Develop a unified design framework: This framework should be able to accommodate a variety of LPWUS and LPWUR implementations while effectively handling different data rates, waveform demands, and coverage requirements without compromising performance and efficiency. The unified design should consider factors such as synchronization accuracy, receiver complexity, and RRM offloading support, while also being flexible enough to adapt to different LPWUS content and payload designs. A thorough study should be conducted to identify the key design components and requirements needed to create a robust and versatile framework that optimizes system performance.
2. Enhance communication capabilities through signal realization in OOK modulation: To convey information more efficiently to OFDM receivers, incorporate signal realization within the OOK modulation. This can be achieved by designing OFDMA sequences in a manner that enables the sharing of the same time and frequency domain among multiple signals. This superposition of OOK and OFDM waveforms will enhance spectral efficiency, allowing for better communication between various receiver types while also improving the overall performance of the system.

By combining the development of a unified design framework with an enhanced signaling approach using OOK modulation, the solution effectively tackles the preference of waveform issue while maintaining performance and efficiency in LPWUS and LPWUR implementations.

### Argument

The proposed solution has the potential to effectively address the preference of waveform issue by providing a unified design framework that caters to a wide range of LPWUS and LPWUR implementations. Leveraging OOK modulation to convey data to OFDM receivers also enhances spectral efficiency, resulting in a system that optimizes performance across various receiver types and waveform demands.

### Spec Impact

Implementing this solution will impact the design and development of LPWUS and LPWUR technology. It will influence the way these systems accommodate different waveform preferences, ensuring seamless adaptability and communication between various receiver types. Furthermore, it will require changes to the specifications guiding LPWUS and LPWUR design and implementation, taking into account the proposed unified design framework and the enhancement of spectral efficiency through OOK modulation.

Here's the filled table evaluating the impact of the new feature on the different 5G NR standard modules:

| | Impact | | Impact |
|---|---|---|---|
| Standard module | (Y/N) | Standard module | (Y/N) |
| Frame Structure | N | PDSCH (incl. DMRS, Rx | Y |
| | | procedure) | |
| SCS & CP, | Y | PUCCH (incl. DMRS, UCI | N |
| Modulation | | multiplexing, Tx | |
| | | procedure) | |
| Sequence Generation | N | PUSCH (incl. DMRS, Tx | N |
| | | procedure) | |
| Initial access SS/PBCH | N | DL HARQ (incl. HARQ-ACK) | N |
| Paging | Y | PDSCH UE Processing Time | N |
| PRACH (incl. RACH | N | PUSCH UE Processing Time | N |
| procedure) | | | |
| RRM | Y | BWP-specific | N |
| RLM | N | SUL-specific | N |
| DL MIMO (incl. Tx | N | CA-specific | N |
| schemes, CSI-RS & | | | |
| related procedure) | | | |
| UL MIMO (incl. Tx | N | MRDC-specific | N |
| schemes, SRS & related | | | |
| procedure) | | | |
| Beam Management, | N | UL Power Control | N |
| QCL & SYNC (incl. | | | |
| TA, TRS, PTRS) | | | |
| PRS (incl. procedure) | N | DL Channel Access | N |
| PDCCH (incl. DMRS, DCI | Y | UL Channel Access | N |
| formats, Rx procedure) | | | |
| Channel Coding | N | L1 Capability | Y |

### Analysis & Examples

SCS & CP, Modulation: The modulation schemes must be adapted to include both OOK signals for one-bit information and OFDMA signals for the additional two bits of information. Example: Update the modulation schemes used in the adapted PDCCH/SSS design.

PDSCH (incl. DMRS, Rx procedure): The PDSCH design must consider the changes to the PDCCH/SSS transmission, such as incorporating OOK and OFDMA signals for different information bits. Example: Adapt the receiver for processing the PDSCH mixed-modulation signals.

Paging: Update paging procedures to handle varying combinations of group IDs and subgroup IDs, depending on the UE's capabilities for detecting OOK or OFDMA signals. Example: Implement new paging processing rules for the different levels of subgroup resolution.

RRM: The radio resource management strategies must be adapted to account for the new mixed-modulation schemes, including the optimization of resource allocation and transmission strategies. Example: Update RRM algorithms to consider the UE's ability to detect and process OOK and/or OFDMA signals.

PDCCH (incl. DMRS, DCI formats, Rx procedure): The PDCCH design needs updates to incorporate the OOK and OFDMA signals, introducing new DCI formats and signaling messages as required. Example: Add new DCI formats to signal group ID and subgroup ID information.

L1 Capability: Update L1 capability reporting by the UE to include information about its support for detecting OOK and/or OFDMA signals containing group and subgroup IDs. Example: Add new fields to the L1 capability report message indicating support for OOK and OFDMA-based signaling.

By implementing these changes, the 5G NR system can effectively support the new feature leveraging the benefits of the hybrid approach (OOK and OFDM) for modulation schemes to improve paging functionality, coverage, and spectral efficiency.

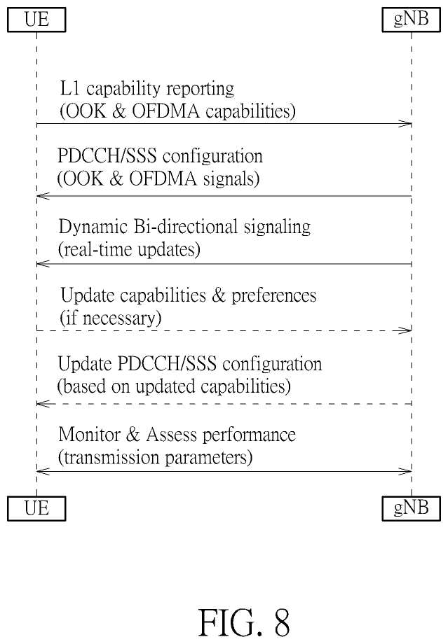

FIG. 8 is a sequence diagram illustrating the detailed signaling procedure between the gNB and UE for the hybrid approach of OOK and OFDM modulation schemes in 5G NR systems. This diagram outlines the signaling procedure between the gNB and UE for configuring and monitoring the hybrid OOK and OFDM modulation approach. The messages between the participants (UE and gNB) represent key steps in the procedure, such as capability reporting, configuration updates, and performance monitoring to ensure efficient communication and adaptive transmission strategies.

### Issue 6: How to Support Dynamic PO

Dynamic Paging Occasion (Dynamic PO) refers to a technique of adaptively configuring Paging Occasions (PO) outside of the regular PO intervals, i.e., PO intervals beyond the fixed periodic structure determined by the paging frame. This approach aims to improve the latency of paging reception for Low-Power Wake-Up Signaling (LP-WUS) in 5G NR systems.

Problem: The main issues addressed by dynamic PO are:
1. Latency Reduction: In conventional PO mechanisms (legacy PO), the UE needs to wait for the regular paging intervals, which could lead to higher latency for receiving paging messages. The dynamic PO aims to reduce the latency by allowing UEs to monitor paging occasions outside the regular paging frame, resulting in faster responses to incoming data and events.
2. Increased Flexibility: Dynamic PO creates more flexibility in resource allocation and scheduling of paging occasions. It allows gNB to adaptively configure POs based on network conditions, UE capabilities, or specific requirements, improving the overall network performance and resource utilization.
3. Energy Efficiency: With dynamic PO, the UE can wake up and monitor POs more selectively, thereby reducing power consumption compared to the more frequent monitoring of fixed PO intervals. This feature is particularly beneficial for IoT and low-power devices that need to preserve battery life.
4. Improved Resilience to Miss Detection: Dynamic PO can help minimize the impact of missed LP-WUS detections. If a UE misses an LP-WUS, it could still potentially wake up and receive paging messages during dynamically assigned POs. This reduces the latency impact due to miss detections.

To implement dynamic PO and leverage its benefits, further studies are needed to understand the optimal trade-offs between monitoring behaviors, energy efficiency, and latency. Additionally, dynamic PO should be evaluated in combination with other techniques like LP-WUS and PEI monitoring to ensure the best possible solutions addressing latency and overall network performance.

solution: To support dynamic PO in conjunction with LP-WUS, modifications must be made in UE behavior, gNB behavior, and signaling between the UE and gNB. Here's an outline of the impact on each aspect, considering this technique only works with LP-WUS:

### 1. UE Behavior:

The UE should be designed to detect LP-WUS and use the received information to adaptively monitor POs outside of the fixed periodic structure determined by the paging frame.
Use the guidance from the LP-WUS to adjust the PO monitoring intervals based on the gNB's instructions.

### 2. gNB Behavior:

The gNB should schedule LP-WUS intelligently based on network conditions, UE capabilities, or specific requirements.
Continuously evaluate the benefit and trade-offs of assigning dynamic POs in conjunction with LP-WUS to ensure optimal network performance, latency, and energy efficiency.

### 3. Signaling Between UE and gNB:

Introduce new messages or extend existing ones in the RRC signaling protocol to inform the UE about dynamically assigned POs and their associated timings, in combination with the LP-WUS information.
Implement adaptive signaling mechanisms that allow the gNB and UE to exchange updates on network conditions, UE preferences, and adjustments related to dynamic PO configurations with respect to LP-WUS.

By incorporating these changes in UE behavior, gNB behavior, and signaling between the UE and gNB, dynamic PO can be effectively supported with LP-WUS in the 5G NR system. This will result in improved latency, energy efficiency, and overall network performance, particularly for low-power IoT devices.

Here's the table evaluating the NR spec impact to support dynamic PO in conjunction with LP-WUS:

| | Impact | | Impact |
|---|---|---|---|
| Standard module | (Y/N) | Standard module | (Y/N) |
| Frame Structure | Y | PDSCH (incl. DMRS, Rx | N |
| | | procedure) | |
| SCS & CP, Modulation | N | PUCCH (incl. DMRS, UCI | N |
| | | multiplexing, Tx | |
| | | procedure) | |
| Sequence Generation | N | PUSCH (incl. DMRS, Tx | N |
| | | procedure) | |
| Initial access SS/PBCH | N | DL HARQ (incl. HARQ-ACK) | N |
| Paging | Y | PDSCH UE Processing Time | N |
| PRACH (incl. RACH | N | PUSCH UE Processing Time | N |
| procedure) | | | |
| RRM | N | BWP-specific | N |
| RLM | N | SUL-specific | N |
| DL MIMO (incl. Tx | N | CA-specific | N |
| schemes, CSI-RS & | | | |
| related procedure) | | | |
| UL MIMO (incl. Tx | N | MRDC-specific | N |
| schemes, SRS & related | | | |
| procedure) | | | |
| Beam Management, | N | UL Power Control | N |
| QCL & SYNC (incl. | | | |
| TA, TRS, PTRS) | | | |
| PRS (incl. procedure) | N | DL Channel Access | N |
| PDCCH (incl. DMRS, DCI | Y | UL Channel Access | N |
| formats, Rx procedure) | | | |
| Channel Coding | N | L1 Capability | Y |

### Analysis and Spec Changes:

1. Frame Structure: The Frame Structure will require modifications to support dynamic Paging Occasions. This may involve defining additional higher-layer signaling to indicate the dynamic PO timings.
2. Paging: The Paging module might need updates to support LP-WUS-based paging. The gNB will schedule and send LP-WUS with dynamic POs, while the UE will monitor and act upon receiving LP-WUS.
3. PDCCH: The PDCCH module may need extensions for DCI formats or new messages to inform UEs about dynamically assigned POs in combination with LP-WUS information.
4. L1 Capability: Add support for dynamic PO and LP-WUS detection to the operational capabilities of Layer 1 for UEs to adaptively monitor POs.

### Examples

1. Frame Structure: Introducing a new higher-layer signaling flag indicating the presence of dynamic POs in the system or an extension to the paging configuration information to include LP-WUS-based paging information with dynamic POs.
2. Paging: Update the paging process to incorporate LP-WUS for triggering dynamic POs. For instance, when the UE receives an LP-WUS, it can monitor the dynamically assigned PO indicated in the LP-WUS information.
3. PDCCH: In the DCI format, include a new field representing dynamic PO information, which the UE can utilize to manage PO monitoring intervals.
4. L1 Capability: Add a new capability bit indicating support for dynamic POs in conjunction with LP-WUS, enabling UEs to adaptively monitor these POs.

Here, I provide more details on the examples for implementing dynamic PO in conjunction with LP-WUS in the 5G NR system:
1. Frame Structure: To enable dynamic POs in conjunction with LP-WUS, a new higher-layer signaling element or an extension to the existing paging configuration information could be introduced. For example, a new parameter could be utilized to indicate the allowed range or density of dynamic POs within the frame structure. By incorporating this information, the gNB can assign dynamic POs more flexibly and effectively manage resources for low-power IoT devices.

DynamicPOInfo ::= SEQUENCE {

| | |
|---|---|
| dynamicPOFlag | BOOLEAN, // True if dynamic POs are |

supported

| | |
|---|---|
| dynamicPORange | INTEGER (1..4096), // Number of |

subframes/frames allowed for dynamic POs

| | |
|---|---|
| dynamicPODensity | ENUMERATED {sparse, moderate, dense} // |

Range density of dynamic POs within the supported range
}
Copy

2. Paging: To effectively manage dynamic POs with LP-WUS, the paging process needs modifications. An extended paging configuration message could be introduced that includes new parameters, such as LP-WUS reception timings and associated dynamic PO assignments. This way, the UE's behavior could be adjusted to monitor POs more selectively and save energy.

ExtendedPagingConfig ::= SEQUENCE {

| | |
|---|---|
| lpwusTimings | SEQUENCE (SIZE(1..maxLPWUSTimings)) OF |

INTEGER(0..maxPagingFrame), // LP-WUS timings in subframes/frames

| | |
|---|---|
| lpwusDynamicPOs | SEQUENCE (SIZE(1..maxLPWUSTimings)) OF |
| INTEGER(0..maxPagingFrame) | // Associated dynamic POs for each |

LP-WUS timing
}
Copy

3. PDCCH: A new field representing dynamic PO information can be added to relevant DCI formats. This field will be used by the gNB to inform the UE about which dynamic PO it should monitor following the LP-WUS reception. The UE can then use this information to wake up and monitor the assigned PO more selectively.

ExtendedDCIFormat ::= SEQUENCE {

| | | |
|---|---|---|
| existingDciFormat | DCIFormat, | // Standard |

DCI format as per existing NR specifications

| | |
|---|---|
| dynamicPoIndicator | INTEGER(0..maxDynamicPOValue) // |

Assigned dynamic PO value for LP-WUS-based paging
}
Copy

4. L1 Capability: Layer 1 capabilities for the UE should include the ability to support dynamic PO with LP-WUS. A new capability bit can be added to indicate that the UE is capable of adaptively monitoring POs based on LP-WUS receptions.

L1CapabilitySupport ::= SEQUENCE {

| | |
|---|---|
| existingL1Capability | Existing L1 Capability, // As per |

existing NR specifications

| | | |
|---|---|---|
| dynamicPoWithLPWUS | BOOLEAN | // True if the UE |

supports dynamic PO in conjunction with LP-WUS
}
Copy

These examples represent possible ways to incorporate dynamic PO support with LP-WUS into the existing 5G NR system. Each example would require further analysis and discussion within the 3GPP standards body to ensure compatibility with existing specifications and seamless integration into the system.

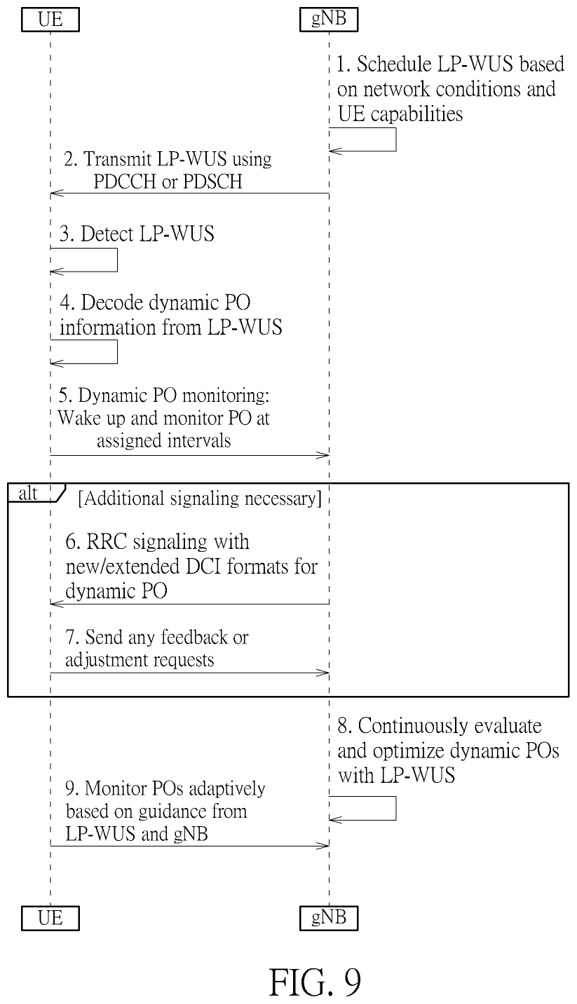

FIG. 9 is a sequence diagram for a procedure to support dynamic PO in the 5G NR system.

This sequence diagram presents the procedure for supporting dynamic PO in a 5G NR system:
1. gNB schedules LP-WUS based on network conditions and UE capabilities.
2. gNB transmits LP-WUS using PDCCH or PDSCH.
3. UE detects and decodes LP-WUS, and extracts dynamic PO information.
4. UE wakes up and monitors PO at assigned intervals based on dynamic PO information.
5. If additional signaling is necessary, the gNB and UE can exchange RRC signaling messages with new or extended DCI formats for dynamic PO and send any required feedback or adjustment requests.
6. gNB continuously evaluates and optimizes dynamic POs with LP-WUS.
7. UE monitors POs adaptively based on guidance from LP-WUS and gNB instructions.
   Issue 7: How to Coexist with R16 RRM Relaxation

Problem: If RRM offloading is considered without taking into account the existing Rel-16 RRM relaxation techniques, there might be several challenges and problems:
1. Higher power consumption: In the absence of RRM relaxation, the main receiver (MR) would need to perform RRM measurements more frequently, leading to higher power consumption for both serving and neighbor cells. This could significantly diminish the power-saving benefits of RRM offloading using LP-WUR.
2. Increased signaling overhead: Without RRM relaxation, the UEs would regularly exchange signaling messages with the network for reporting RRM measurement results. This increased signaling overhead can negatively affect network performance, especially for low-power IoT devices.
3. Lower network efficiency: Considering RRM offloading without RRM relaxation may not allow for the most efficient use of network resources. With the RRM relaxation techniques in Rel-16, UEs can perform measurements less frequently depending on their mobility state and position within the cell, leading to a more optimized use of network resources.
4. Missed opportunities for maximizing potential benefits: By ignoring the existing RRM relaxation techniques, the potential benefits of combining RRM offloading with RRM relaxation might be missed. The collaboration between the main receiver and LP-WUR could lead to greater power savings, enhanced network performance, and overall improved system efficiency.

In summary, not considering the Rel-16 RRM relaxation techniques while implementing RRM offloading might result in higher power consumption, increased signaling overhead, decreased network efficiency, and missed opportunities for maximizing the potential synergies between RRM offloading and RRM relaxation. It's essential to take Rel-16 RRM relaxation techniques into account to ensure improved network performance and power savings, especially for IoT devices and low-power UEs in the 5G NR system.

Solution: To address the issue of coexistence of Rel-16 RRM relaxation, the following two proposals are suggested:
1. Focus on LPWUS content and payload design for LPWUR in the R18 study, under conditions of NR SSB reuse, 2 us timing error, and 2 ppm frequency error, while ensuring RRM offloading support. This approach will help identify potential optimizations in payload design and efficient mechanisms for maintaining synchronization.
2. Study LPWUS-based RRM offloading in coordination with the existing Rel-16 RRM relaxation in power-saving WID. This will involve exploring the potential benefits and challenges of integrating LPWUS-based RRM offloading with Rel-16 RRM relaxation strategies and identifying necessary adjustments to support their coexistence.

Argument: The proposed solution addresses the coexistence issue by considering the specific conditions and requirements of LPWUS and LPWUR designs, incorporating NR SSB reuse, and examining the implications of Rel-16 RRM relaxation. By focusing on both the content and payload design for LPWUR and the coordination with existing RRM relaxation strategies, the solution provides an optimal balance between the system requirements, realizing a more efficient and adaptable framework for LPWUS integration.

Spec Impact: Implementing these proposals will impact the design and development of LPWUS and LPWUR technology and the incorporation of the Rel-16 RRM relaxation strategies. This will require changes to the specifications guiding LPWUS and LPWUR design and implementation to take into account the proposed integration and coexistence of RRM offloading support, as well as potential adjustments in LPWUS payload design and synchronization mechanisms. These changes will ensure that the system's performance and efficiency are not compromised while maximizing the benefits of LPWUS-based RRM offloading in coordination with Rel-16 RRM relaxation strategies.

To implement RRM offloading without considering the existing Rel-16 RRM relaxation techniques, a solution can be proposed that addresses UE behavior, gNB behavior, and signaling between the UE and gNB. Here's a possible solution:

### 1. UE Behavior:

UE should utilize the Low-Power Wake-Up Receiver (LP-WUR) to receive RRM related signals from the gNB during low-power state operation, while the main radio receiver (MR) is in the low-power state.
Determine and perform RRM measurements for the serving or camping cell based on the received signals, with the help of LP-WUR.
Continuously monitor the RRM performance using LP-WUR and coordinate with neighboring cells for RRM offloading, load balancing, or handover procedures when necessary.

### 2. gNB Behavior:

Schedule and transmit RRM related signals to the UE using low-power signaling mechanisms, targeting the UEs with LP-WUR for efficient RRM offloading and power-saving purposes.
Receive RRM measurement results from the UE and utilize them for network optimization, load balancing, or handover decisions within the network.
Regularly optimize and adapt RRM offloading without RRM relaxation techniques to ensure maximum power-saving benefits and seamless network performance.

### 3. Signaling Between UE and gNB:

Implement efficient signaling mechanisms for the exchange of RRM-related information between the UE and the gNB, considering the use of LP-WUR in the UE, in order to reduce signaling overhead and power consumption.
Introduce new or extended messages, as part of the RRC signaling protocol, to facilitate the exchange of RRM measurement results, coordination data with neighboring cells, or necessary adjustments regarding RRM offloading.

By implementing this solution, RRM offloading can be achieved without relying on Rel-16 RRM relaxation techniques. This approach leverages the use of the LP-WUR to perform RRM measurements while the MR is in a low-power state, allowing for power-saving benefits and coordinated RRM offloading procedures between cells. However, it should be noted that the best performance may be achieved by incorporating Rel-16 RRM relaxation techniques to maximize synergies between RRM offloading and RRM relaxation.

Here's the table evaluating the NR spec impact to support RRM offloading without considering the existing Rel-16 RRM relaxation techniques:

| | Impact | | Impact |
|---|---|---|---|
| Standard module | (Y/N) | Standard module | (Y/N) |
| Frame Structure | Y | PDSCH (incl. DMRS, Rx | N |
| | | procedure) | |
| SCS & CP, Modulation | N | PUCCH (incl. DMRS, UCI | N |
| | | multiplexing, Tx | |
| | | procedure) | |
| Sequence Generation | N | PUSCH (incl. DMRS, Tx | N |
| | | procedure) | |
| Initial access SS/PBCH | N | DL HARQ (incl. HARQ-ACK) | N |
| Paging | N | PDSCH UE Processing Time | N |
| PRACH (incl. RACH | N | PUSCH UE Processing Time | N |
| procedure) | | | |
| RRM | Y | BWP-specific | N |
| RLM | N | SUL-specific | N |
| DL MIMO (incl. Tx | N | CA-specific | N |
| schemes, CSI-RS & | | | |
| related procedure) | | | |
| UL MIMO (incl. Tx | N | MRDC-specific | N |
| schemes, SRS & related | | | |
| procedure) | | | |
| Beam Management, | N | UL Power Control | N |
| QCL & SYNC (incl. | | | |
| TA, TRS, PTRS) | | | |
| PRS (incl. procedure) | N | DL Channel Access | N |
| PDCCH (incl. DMRS, DCI | Y | UL Channel Access | N |
| formats, Rx procedure) | | | |
| Channel Coding | N | L1 Capability | Y |

Analysis and spec changes for the impacted modules:
1. Frame Structure: Introduce changes to support low-power signaling mechanisms for transmitting RRM-related signals from the gNB to the UE, targeting LP-WUR.

Example: Define new signaling patterns for RRM-related signals suited for LP-WUR in the frame structure, considering possible overlapping patterns with other signals for efficient use.
2. RRM: Update the RRM module to include the use of LP-WUR for RRM measurements and offloading, considering both serving and neighboring cells.

Example: Introduce new parameters to configure LP-WUR for RRM measurements and offloading, defining appropriate coordination policies among neighboring cells.
3. PDCCH: Extend PDCCH module to support efficient signaling mechanisms to exchange RRM-related information between the UE and gNB, considering the use of LP-WUR in the UE.

Example: Define new DCI formats or modify existing ones to include RRM measurement results, coordination data with neighboring cells, or necessary adjustments regarding RRM offloading.
4. L1 Capability: Include support for RRM offloading without Rel-16 RRM relaxation techniques in UE's Layer 1 operational capabilities.

Example: Introduce a new capability bit in the L1 capability information, indicating support for RRM offloading with LP-WUR without relying on Rel-16 RRM relaxation techniques.

By incorporating these changes to the impacted modules, it's possible to implement RRM offloading without considering Rel-16 RRM relaxation techniques, leveraging the use of the LP-WUR to coordinate RRM measurements and offloading among neighboring cells.

Here are more detailed analyses and spec changes for the impacted modules to implement RRM offloading without considering Rel-16 RRM relaxation techniques:
1. Frame Structure: Introducing changes to support low-power signaling mechanisms requires adjustments to the frame structure definition. This can include creating new subframes, slots, or resource allocation patterns specifically tailored for efficient RRM-related signaling between the gNB and UE.

### Examples of Spec Changes:

Define a new subframe structure within the frame to accommodate RRM-related signals specifically for LP-WUR.
Introduce new patterns for signal transmission based on the LP-WUR wakeup intervals, using a dynamic or pre-configured approach.
2. RRM: The RRM module needs an update to incorporate the use of LP-WUR for RRM measurements and offloading. This involves considering the LP-WUR's capabilities and limitations in order to provide the most power-efficient RRM offloading options.

### Examples of Spec Changes:

Add a section in the RRM specifications defining how the LP-WUR can be employed for RRM measurement offloading without relying on Rel-16 RRM relaxation techniques.
Introduce specific performance and measurement requirements that UEs and gNBs must achieve for RRM offloading using LP-WUR.
3. PDCCH: The PDCCH module should be extended to support efficient signaling mechanisms for exchanging RRM-related information between the UE and gNB. This may involve defining new DCI formats or modifying existing ones to include the necessary information and maintain a low signaling overhead.

### Examples of Spec Changes:

Add new fields to the existing DCI formats to accommodate RRM measurement results coordination data with neighboring cells.
Create new DCI formats specifically for transmitting RRM measurement and coordination data within the context of RRM offloading without RRM relaxation techniques.
4. L1 Capability: To include support for RRM offloading without Rel-16 RRM relaxation in the UE's Layer 1 operational capabilities, the L1 Capability information should be updated.

### Examples of Spec Changes:

Extend the L1 Capability Information IE (Information Element) by adding new fields or capability flags indicating the UE's support for RRM offloading without considering RRM relaxation techniques. This can ensure proper configuration and operation between the UE and gNB.
Define additional signaling procedures, if required, for the UE and gNB to negotiate their capabilities and support for RRM offloading without relying on RRM relaxation techniques.

By incorporating these changes into the impacted modules, the implementation of RRM offloading without considering Rel-16 RRM relaxation techniques can be made possible. This solution enables power-saving benefits and coordinated RRM offloading procedures by leveraging the capabilities of the LP-WUR in both serving and neighboring cells.

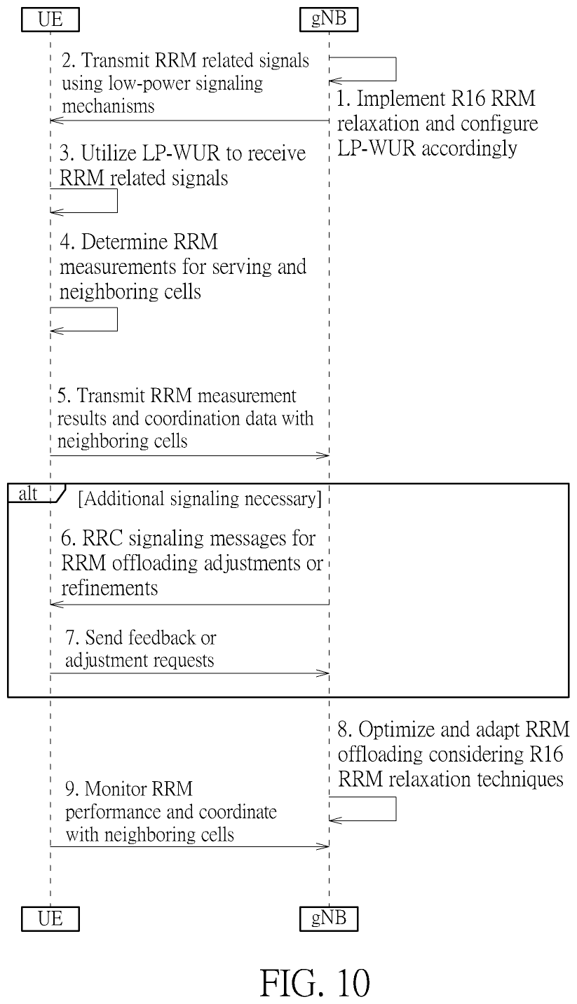

FIG. 10 is a sequence diagram for a procedure to support RRM offloading with Rel-16 RRM relaxation in the 5G NR system.

This sequence diagram presents the procedure for supporting RRM offloading with Rel-16 RRM relaxation in a 5G NR system:
1. gNB implements R16 RRM relaxation and configures LP-WUR accordingly.
2. gNB transmits RRM related signals to the UE using low-power signaling mechanisms.
3. UE utilizes LP-WUR to receive RRM related signals.
4. UE determines RRM measurements for the serving and neighboring cells based on received signals.
5. UE transmits RRM measurement results and coordination data with neighboring cells to gNB.
6. If additional signaling is necessary, the gNB and UE can exchange RRC signaling messages to refine or adjust RRM offloading procedures.
7. gNB continuously optimizes and adapts RRM offloading while considering R16 RRM relaxation techniques.
8. UE monitors RRM performance and coordinates with neighboring cells for RRM offloading, load balancing, or handover procedures.

### Issue 8: How to Support LPWUS RRM

Problem: Supporting LP-WUS-based RRM involves challenges such as integrating with existing systems, efficient resource allocation, accommodating diverse devices, balancing performance trade-offs, managing network congestion and scalability in dense deployments, and achieving standardization and interoperability. Addressing these challenges requires strategical planning, collaboration among industry stakeholders, and innovative approaches to harness the benefits of LP-WUS-based RRM without compromising system performance and reliability.

Timeline: The timeline of UE and gNB procedures to perform LP-WUS-based RRM mainly depends on the specific requirements, technology advancements, and network parameters. It begins with configuration and resource allocation, done by the gNB, typically spanning from few milliseconds to seconds. The UE monitors LP-WUS transmissions periodically, based on the configured durations (e.g., 320 ms, 640 ms, 1280 ms). Upon receiving an LP-WUS, the UE decodes control information and triggers necessary actions, such as synchronization or measurement. The entire process can vary across implementations, and the actual timelines may be influenced by network and device capabilities

Root cause: The root cause preventing support for LP-WUS-based RRM is the complexity of integrating it into existing systems without disrupting performance. This involves resource allocation, device compatibility, network congestion, and scalability management in dense deployments. Addressing this requires coordinated efforts from industry stakeholders, innovative solutions, and standardized practices for seamless adoption while maintaining overall system reliability and performance.

Solution: To support LP-WUS-based RRM, the following solution can be implemented, outlining the steps involved for the UE and gNB:
1. Configuration: The gNB configures the UE with LP-WUS parameters, such as time and frequency resources, transmission periodicity, and other relevant information, via RRC signaling messages.
2. Reception: The UE monitors the allocated resources periodically for LP-WUS transmissions while in a low-power state, waking up at predefined intervals according to the configuration and network conditions.
3. Determination: Upon receiving an LP-WUS, the UE decodes the associated control information to determine the purpose of the signal, such as synchronization purposes or measurement requirements.
4. Performing tasks: Based on the decoded control information, the UE performs the required tasks, ranging from time and frequency synchronization to network measurements and RRM operations.
5. Reporting and transmissions: Once the UE completes the required tasks, it may need to report results, such as measurement reports, to the gNB using appropriate uplink control channels (e.g., PUCCH for HARQ-ACK or SR, and PUSCH for measurement reports).
6. Resource release: After completing the tasks and any required transmissions, the UE reverts to the low-power state to conserve energy until the next LP-WUS monitoring period.

This solution ensures that LP-WUS-based RRM is effectively integrated into the system, allowing the UE to perform necessary tasks while conserving power and maintaining connectivity with the network. The exact procedures and specific parameters may vary depending on the implemented system and standards.

argument: Pros of LP-WUS-based RRM include improved power efficiency, faster wake-up transitions, scalability, and adaptability to network conditions. Cons involve integration complexity, resource management challenges, potential performance trade-offs, and the need for standardization and interoperability. By addressing these challenges during design and standardization, LP-WUS-based RRM can provide power-saving benefits and enhanced device management capabilities in communication systems.

Spec impact: Based on the table below, implementing LP-WUS-based RRM impacts specific standard modules, such as Frame Structure, Sequence Generation, Initial access SS/PBCH, Paging, PRACH, RRM, Beam Management, and PRS. These impacted modules are crucial for enabling effective low-power wake-up functionality without affecting other modules related to data transmission and reception.

LP-WUS-based RRM allows devices to enter low-power states while periodically monitoring for wake-up signals. The integration of this feature must be carefully managed for the impacted standard modules while minimizing the impact on non-impacted modules. This approach ensures energy efficiency and maintains network connectivity for the devices, improving device battery life and responsiveness, and addressing the requirements of massive IoT and dense deployment scenarios.

| | Impact | | Impact |
|---|---|---|---|
| Standard Module | (Y/N) | Standard Module | (Y/N) |
| Frame Structure | Y | PDSCH (incl. DMRS, Rx | N |
| | | procedure) | |
| SCS & CP, Modulation | Y | PUCCH (incl. DMRS, UCI | N |
| | | multiplexing, Tx | |
| | | procedure) | |
| Sequence Generation | Y | PUSCH (incl. DMRS, Tx | N |
| | | procedure) | |
| Initial access SS/PBCH | Y | DL HARQ (incl. HARQ-ACK) | N |
| Paging | Y | PDSCH UE Processing Time | N |
| PRACH (incl. RACH | Y | PUSCH UE Processing Time | N |
| procedure) | | | |
| RRM | Y | BWP-specific | N |
| RLM | N | SUL-specific | N |
| DL MIMO (incl. Tx | N | CA-specific | N |
| schemes, CSI-RS & | | | |
| related procedure) | | | |
| UL MIMO (incl. Tx | N | MRDC-specific | N |
| schemes, SRS & related | | | |
| procedure) | | | |
| Beam Management, | Y | UL Power Control | N |
| QCL & SYNC (incl. | | | |
| TA, TRS, PTRS) | | | |
| PRS (incl. procedure) | Y | DL Channel Access | N |
| PDCCH (incl. DMRS, DCI | N | UL Channel Access | N |
| formats, Rx procedure) | | | |
| Channel Coding | N | L1 Capability | N |

Frame Structure: The impact of LP-WUS-based RRM on the frame structure involves integrating LP-WUS transmissions into the existing structure without disrupting other signals. Here's an example:

Consider a 5G NR system deploying LP-WUS-based RRM. In a typical NR radio frame, which lasts for 10 ms, there are ten 1 ms subframes. Each subframe contains multiple slots, the number of which depends on the subcarrier spacing.

To accommodate LP-WUS transmissions, the system may allocate specific resources, such as a dedicated slot or a set of symbols within a subframe, for transmitting LP-WUS signals, while the rest of the slots continue to carry regular data, control channels, and other signals.

By reserving resources in the frame structure for LP-WUS, low-power devices can monitor these transmissions for synchronization and measurement purposes while remaining in a low-power state most of the time, thus conserving energy.

The challenge lies in effectively designing and allocating resources, minimizing interference with existing signals, and keeping the impact minimal across other elements of the frame structure.

SCS & CP, Modulation: The impact of LP-WUS-based RRM on SCS (Subcarrier Spacing), CP (Cyclic Prefix), and Modulation involves finding suitable transmission parameters that enable good reception for low-power devices while minimizing interference with regular communication.

Example: In a 5G NR system deploying LP-WUS-based RRM, the choice of subcarrier spacing, cyclic prefix, and modulation for LP-WUS transmissions must be made carefully. Suppose the regular data transmission utilizes 30 kHz subcarrier spacing and a standard cyclic prefix. To achieve better reception in low-power devices, the LP-WUS transmission may use a lower subcarrier spacing, such as 15 kHz, and an extended cyclic prefix to improve time-frequency localization and mitigate multipath effects.

Regarding modulation, LP-WUS transmissions can use a simpler modulation scheme, such as BPSK or OOK (On-Off Keying), instead of higher-order modulations like QAM. Using simpler modulation schemes enhances the reception reliability for low-power devices, trading off data rate for increased robustness.

Overall, the impact of SCS, CP, and modulation adaptations helps meet the requirements of LP-WUS-based RRM, ensuring effective reception for low-power devices, while minimizing interference and coexistence issues with other ongoing transmissions. The approach should strike a balance between robust LP-WUS reception and efficient utilization of network resources.

Sequence Generation: The impact of LP-WUS-based RRM on Sequence Generation involves creating unique and distinguishable sequences specifically for LP-WUS transmissions that allow low-power devices to identify and synchronize with the signal.

Example: In a 5G NR system, sequence generation for regular data and control channels, such as PSS or SSS, utilizes Zadoff-Chu or Gold sequences to provide good autocorrelation and cross-correlation properties. When implementing LP-WUS-based RRM, a new set of unique sequences needs to be generated for the LP-WUS transmissions to facilitate reliable detection and minimized interference.

Suppose developers design a new set of orthogonal sequences or maintain existing channel sequences, such as PSS or SSS, specifically for LP-WUS. In either case, these sequences should possess distinct properties, enabling low-power devices to easily detect and differentiate the LP-WUS signals from other ongoing transmissions.

In summary, when supporting LP-WUS-based RRM, the impact on sequence generation consists of defining separate, distinguishable sequences for LP-WUS transmission. This adaptation increases the robustness and reliability of detection for low-power devices while minimizing interference with regular signals in the system.

Initial access SS/PBCH: The impact of LP-WUS-based RRM on Initial Access SS/PBCH involves enabling low-power devices to maintain limited network connectivity while remaining in a low-power state by using LP-WUS transmissions for synchronization and limited system information.

Example: In a 5G NR system, the initial access procedure relies on Synchronization Signal (SS) blocks, which contain PSS (Primary Synchronization Signal), SSS (Secondary Synchronization Signal), and PBCH (Physical Broadcast Channel) for providing synchronization and initial system information to UEs.

When implementing LP-WUS-based RRM, the initial access procedure will be modified to accommodate the LP-WUS signal. Instead of relying solely on the SS/PBCH blocks, a low-power device can decode LP-WUS signals for basic synchronization and system information. This is particularly beneficial when the device solely requires network synchronization or information such as Time Advance (TA) and does not require full data transmission capabilities in low-power state.

As a result, the impact of LP-WUS-based RRM on initial access SS/PBCH involves adapting the existing initial access mechanisms to include LP-WUS signals, providing minimum required synchronization and network connectivity while allowing devices to stay in low-power mode, conserving energy and extending battery life.

It's essential to design these adaptations with minimal interference and coexistence issues while effectively managing network resources and device performance.

Paging: The impact of LP-WUS-based RRM on Paging involves modifying the paging procedure to allow low-power devices to monitor for paging messages through LP-WUS transmissions while remaining in a low-power state.

Example: In a 5G NR system, a UE in idle mode periodically wakes up and monitors PDCCH (Physical Downlink Control Channel) to check for any paging messages. This periodic wake-up consumes energy and affects battery life, especially in IoT devices and other low-power scenarios.

With LP-WUS-based RRM, the paging procedure can be adapted to allow low-power devices to monitor LP-WUS transmissions for paging messages instead of the conventional PDCCH monitoring. In this case, LP-WUS transmissions will carry or indicate paging-related information, such as UE-specific identifiers or a pointer to the corresponding PDCCH resource.

Upon detecting an LP-WUS with paging information, the low-power device can wake up fully and proceed with standard paging procedures by reading the associated PDCCH resource or obtain necessary information directly from the LP-WUS. This approach saves energy by minimizing the frequency and duration of wake-up periods for low-power devices and helps to extend their battery life.

The impact of LP-WUS-based RRM on Paging lies in optimizing the paging procedure for improved energy efficiency without compromising reliable paging message reception and responsiveness of low-power devices to network-initiated communications.

PRACH (incl. RACH procedure): The impact of LP-WUS-based RRM on PRACH, including the RACH (Random Access Channel) procedure, involves adjusting the RACH procedure to allow low-power devices to initiate and maintain access to the network efficiently upon LP-WUS-based events, while staying in a low-power state most of the time.

Example: In a 5G NR system, the RACH procedure consists of a UE transmitting a preamble on the PRACH and subsequently receiving a response from the gNB, allowing the UE to access network resources.

With LP-WUS-based RRM, the RACH procedure can be adapted to coordinate with the LP-WUS signals. When a low-power device detects an LP-WUS transmission that requires it to access the network, the device initiates the RACH procedure by transmitting a preamble on the PRACH as specified by the LP-WUS information (e.g., specific RACH resource configuration).

Upon successful RACH completion, the device may transition to a higher-power state for further communication, such as data transmission or reception. Once the required communications are concluded, the device returns to a low-power state, monitoring LP-WUS transmissions for further network access events.

The impact of LP-WUS-based RRM on PRACH, including the RACH procedure, is the adaptation of the RACH mechanism to optimize network access for low-power devices. This approach improves energy efficiency by easing transitions between low-power and active states while ensuring reliable network access and maintaining device responsiveness.

RRM: The impact of LP-WUS-based RRM on Radio Resource Management (RRM) involves adapting RRM procedures to accommodate low-power devices in terms of resource allocation, scheduling, and measurement reporting, while maintaining the overall network performance.

Example: In a 5G NR system that deploys LP-WUS-based RRM, the network must be optimized to manage different types of devices, including low-power devices such as IoT sensors, and traditional devices like smartphones.
1. Resource Allocation: RRM algorithms must consider LP-WUS transmissions when allocating radio resources to UEs since low-power devices need dedicated resources for monitoring LP-WUS signals in addition to regular data transmission resources.
2. Scheduling: The network scheduler should take into account the low-power state of UEs and schedule resources according to the LP-WUS-based RRM requirements, like assigning a specific periodicity for LP-WUS monitoring or ensuring timely paging message delivery through LP-WUS.
3. Measurement Reporting: Low-power devices might perform limited measurements while in low-power state, such as monitoring LP-WUS signals for significant changes in channel conditions, and report these measurements to the network. RRM strategies must be adapted to process these measurement reports and make informed decisions on network optimization or handovers while considering the low-power constraints.

The impact of LP-WUS-based RRM on the overall RRM process involves making appropriate adaptations to efficiently manage low-power devices without compromising network performance, device responsiveness, and efficiently utilizing network resources.

Beam Management, QCL & SYNC (incl. TA, TRS, PTRS): The impact of LP-WUS-based RRM on Beam Management, QCL (Quasi-Co-Location), and SYNC (including TA, TRS, and PTRS) involves optimizing these processes to efficiently support low-power devices while ensuring proper synchronization, beam management, and signal co-location.

Example: In a 5G NR system deploying LP-WUS-based RRM, beam management, QCL, and SYNC procedures must be adapted, particularly considering low-power devices and LP-WUS transmissions.
1. Beam Management: The gNB may configure UEs with beam-specific LP-WUS sub-frames, particularly when devices use different beams for LP-WUS monitoring and data transmission. This configuration ensures that low-power devices can monitor LP-WUS transmissions effectively and accurately while in low-power state, and adjust their beams accordingly when transitioning to higher-power states.
2. QCL & SYNC: To maintain synchronization in a low-power state, LP-WUS transmissions may incorporate TA (Timing Advance), TRS (Transmission Reception Switching) or PTRS (Phase Tracking Reference Signal) information that low-power devices can utilize. These adaptations help devices stay synchronized with the network and facilitate smooth transitions between low-power and active states, without resource-heavy full synchronization processes.

By optimizing the Beam Management, QCL, and SYNC processes to accommodate LP-WUS-based RRM, UEs can effectively function in low-power states while maintaining proper synchronization and beam alignment with the network. This ensures seamless connectivity and energy-efficient operations, particularly beneficial for IoT devices and other low-power scenarios.

PRS (incl. procedure): The impact of LP-WUS-based RRM on Positioning Reference Signal (PRS) and related procedures involves adapting the PRS generation and transmission to support the low-power devices' positioning requirements while operating in a low-power state.

Example: In a 5G NR system deploying LP-WUS-based RRM, PRS generation and transmission must be configured to ensure low-power devices can effectively estimate their position while in a low-power state.
1. PRS Generation: PRS resources may need to be coordinated with LP-WUS transmissions to ensure that low-power devices can monitor both LP-WUS and PRS signals during their periodic wake-up intervals. It allows the devices to gather positioning information without having to fully wake up or monitor additional resources, thus maintaining energy efficiency.
2. PRS Procedure: The network may need to adjust the PRS procedures for low-power devices, such as adapting PRS transmission periodicity, measurement reporting, or scheduling, to suit the limited capabilities and requirements of low-power devices.

By optimizing PRS generation and transmission procedures while considering LP-WUS-based RRM requirements, low-power devices can maintain proper positioning capabilities while in a low-power state. This adaptation ensures that the devices have highly-accurate positioning information available at all times, even during low-power operation, significantly improving the effectiveness of location-based applications and services.

The proposed specification modifications based on the analysis of each impacted module are:
1. Frame Structure: Introduce dedicated resources for LP-WUS transmissions within the NR radio frame structure, such as specific slots or symbols, for enabling low-power devices to monitor LP-WUS signals.
2. SCS & CP, Modulation: Define separate modulation, subcarrier spacing, and cyclic prefix configurations for LP-WUS transmissions, focusing on enhancing robustness and reception reliability for low-power devices, such as using BPSK modulation, lower subcarrier spacing, and extended cyclic prefix.
3. Sequence Generation: Specify a new set of sequences, such as Zadoff-Chu or Gold sequences, for LP-WUS transmissions with appropriate auto-correlation, cross-correlation, and orthogonality properties, for avoiding interference with other signals.
4. Initial access SS/PBCH: Update the initial access procedure to include LP-WUS transmissions as an alternative synchronization and system information source for low-power devices.
5. Paging: Integrate the LP-WUS transmissions with the paging procedure, reserving specific resources for delivering LP-WUS-based paging messages, ensuring efficient paging reception by low-power devices.
6. PRACH (incl. RACH procedure): Adapt the RACH procedure to coordinate with the LP-WUS signals for low-power devices, such as specifying RACH resources and configurations based on LP-WUS information, enabling smooth transitions between low-power and active states.
7. RRM: Modify RRM algorithms to accommodate the measurement requirements of low-power devices, incorporating RRM tasks offloaded to the LP-WUR, and updating resource allocation, measurement reporting and scheduling to support low-power operation.
8. Beam Management, QCL & SYNC (incl. TA, TRS, PTRS): Ensure that beam management, QCL, and SYNC procedures are adapted to incorporate TA, TRS, and PTRS information in LP-WUS transmissions, enabling devices to maintain proper synchronization and beam alignment while in a low-power state.
9. PRS (incl. procedure): Coordinate PRS resources with LP-WUS transmissions and adapt PRS procedures to facilitate positioning for low-power devices, ensuring adequate positioning accuracy during low-power operation.

These proposed specification modifications provide a comprehensive framework for supporting LP-WUS RRM in 5G NR, enabling seamless integration of low-power wake-up receivers and their RRM offloading capabilities.

Low-Power Wake-Up Receiver (LPWUR) can help perform RRM (Radio Resource Management) offloading by reducing the measurement burden on the main radio receiver (MR) while still maintaining network performance. Here's an overview of how LPWUR performs RRM offloading:
1. Low-power state: The main radio receiver (MR) enters a low-power or sleep state during periods of inactivity to conserve power consumption. LPWUR remains active, continuously or intermittently monitoring incoming signals instead of the MR.
2. Monitoring RRM measurements: While the MR is in a low-power state, LPWUR listens for signals related to RRM measurements, particularly for the serving or camping cell. LPWUR may be able to perform measurements related to signal quality, signal power, or detection rate of LP-WUS and other synchronization signals.
3. Reduced measurement intervals: Depending on the performance criteria in the sleep state, the Rel-16 specification outlines two methods for measurement relaxation: relaxing measurement intervals with scaling factors (Method 1) or stopping measurements for up to 1 hour (Method 2). LPWUR monitors for the required RRM signals while the MR follows these relaxation methods.
4. Maintaining performance: LPWUR ensures that adequate RRM measurements are carried out while the MR is in a low-power state, helping maintain network performance while reducing the measurement burden on the MR.
5. Coordinating with neighboring cells: LPWUR can also synchronize and coordinate with neighboring cells for RRM offloading in situations like load balancing or handover procedures.

By incorporating LPWUR in RRM measurement monitoring, devices can effectively offload RRM measurements from the main radio receiver, maintaining performance while reducing power consumption.

| Step | Description |
|---|---|
| 1. Low-power | The main radio receiver (MR) enters a low-power |
| state | or sleep state; LPWUR remains active for |
| | monitoring. |
| 2. Monitoring RRM | LPWUR listens for signals related to RRM |
| measurements | measurements for the serving or camping cell. |
| 3. Reduced | LPWUR monitors required RRM signals while the |
| measurement | MR follows measurement relaxation methods from |
| intervals | Rel-16. |
| 4. Maintaining | LPWUR ensures adequate RRM measurements are |
| performance | carried out, maintaining network performance. |
| 5. Coordinating | LPWUR synchronizes and coordinates with |
| with neighboring | neighboring cells for RRM offloading in |
| cells | situations like load balancing or handover |
| | procedures. |

This table provides an overview of how LPWUR performs RRM offloading by reducing the measurement burden on the main radio receiver while maintaining network performance and coordinating with neighboring cells.

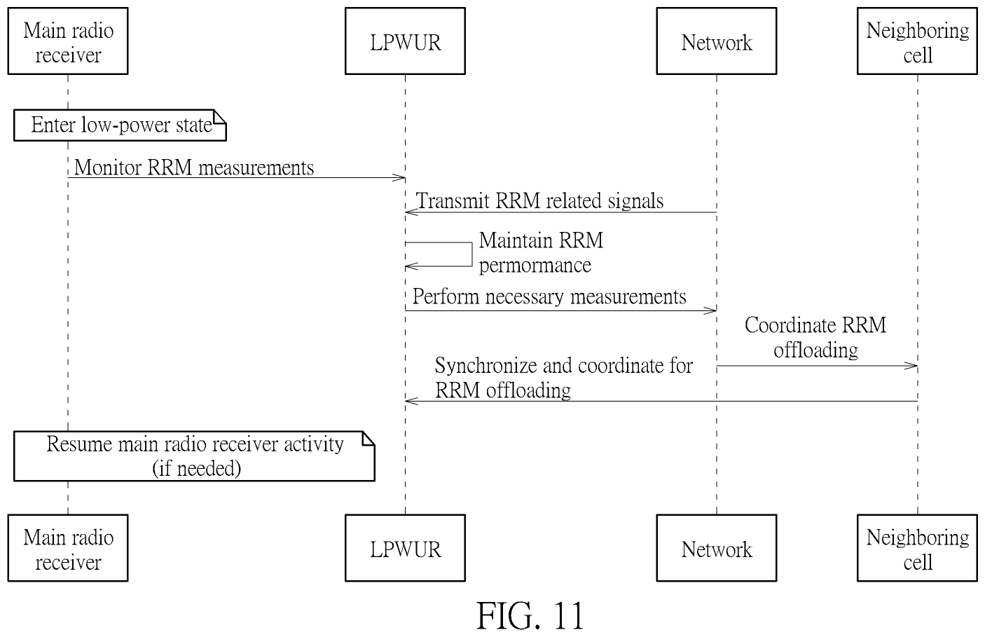

FIG. 11 is a sequence diagram illustrating the procedure of how LPWUR performs RRM offloading. This diagram describes the interactions between the Main Radio Receiver (MRR), LPWUR, Network, and Neighboring Cell (NC) around RRM offloading. It demonstrates the MRR entering a low-power state, LPWUR monitoring RRM measurements, maintaining RRM performance, and coordinating with neighboring cells for RRM offloading.

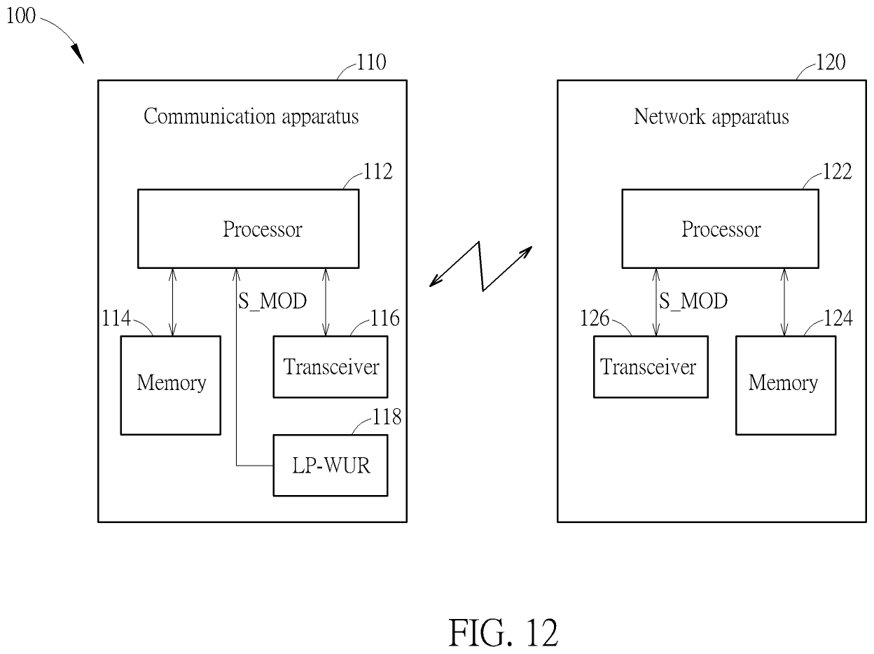

FIG. 12 is a diagram illustrating a communication system according to an embodiment of the present invention. The communication system 100 includes a communication apparatus 110 and a network apparatus 120. Each of communication apparatus 110 and network apparatus 120 may perform various functions to implement schemes, techniques, processes and methods described herein. The communication apparatus 110 may be a part of an electronic apparatus, which may be an user equipment (UE) such as a portable or mobile apparatus, a wearable apparatus, a wireless communication apparatus or a computing apparatus. For instance, the communication apparatus 110 may be implemented in a smartphone, a smartwatch, a personal digital assistant, a digital camera, or a computing equipment such as a tablet computer, a laptop computer or a notebook computer. The communication apparatus 110 may also be a part of a machine type apparatus, which may be an Internet of Things (IoT), Narrowband Internet of Things (NB-IoT), or Industrial Internet of Things (IIOT) apparatus such as an immobile or a stationary apparatus, a home apparatus, a wire communication apparatus or a computing apparatus. For instance, the communication apparatus 110 may be implemented in a smart thermostat, a smart fridge, a smart door lock, a wireless speaker or a home control center. Alternatively, the communication apparatus 110 may be implemented in the form of one or more integrated-circuits (ICs) such as, for example and without limitation, one or more single-core processors, one or more multi-core processors, one or more reduced-instruction set computing (RISC) processors, or one or more complex-instruction-set-computing (CISC) processors. The communication apparatus 110 may include at least some of those components shown in FIG. 12 such as a processor 112, for example. The communication apparatus 110 may further include one or more other components not pertinent to the proposed scheme of the present disclosure (e.g., internal power supply, display device and/or user interface device), and, thus, such component(s) of communication apparatus 110 are neither shown in FIG. 12 nor described below in the interest of simplicity and brevity.

The network apparatus 120 may be a part of a network device, which may be a network node such as a satellite, a base station, a small cell, a router or a gateway. For instance, the network apparatus 120 may be implemented in an Evolved Node B (eNodeB) in an LTE network, in a Next Generation Node B (gNB) in a 5G New Radio (NR), IoT, NB-IoT or IIOT network or in a satellite or base station in a 6G network. Alternatively, the network apparatus 120 may be implemented in the form of one or more chips such as, for example and without limitation, one or more single-core processors, one or more multi-core processors, or one or more RISC or CISC processors. The network apparatus 120 may include at least some of those components shown in FIG. 12 such as a processor 122, for example. The network apparatus 120 may further include one or more other components not pertinent to the proposed scheme of the present disclosure (e.g., internal power supply, display device and/or user interface device), and, thus, such component(s) of the network apparatus 120 are neither shown in FIG. 12 nor described below in the interest of simplicity and brevity.

In one aspect, each of processor 112 and processor 122 may be implemented in the form of one or more single-core processors, one or more multi-core processors, or one or more CISC processors. That is, even though a singular term “a processor” is used herein to refer to processor 112 and processor 122, each of processor 112 and processor 122 include may multiple processors in some implementations and a single processor in other implementations in accordance with the present disclosure. In another aspect, each of processor 112 and processor 122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 112 and processor 122 is a special-purpose machine specifically designed, arranged and configured to perform specific tasks.

In some implementations, the communication apparatus 110 may also include an MR (e.g., transceiver 116) coupled to the processor 112 and capable of wirelessly transmitting and receiving user data, and a low power wakeup receiver (LP-WUR) 118 coupled to the processor 112 and capable of receiving existing synchronization signals (e.g., a primary signal and synchronization (PSS) a secondary synchronization signal (SSS)) and a low power wakeup signal (LP-WUS). If the LP-WUR 118 cannot receive the existing PSS/SSS, the LP-WUR 118 is arranged to receive a new LP-WUR synchronization signal (LP-SS) that is distinct from the existing PSS/SSS. The transceiver 116 includes a transmitter used to support the transmit (TX) function and a receiver used to support the receive (RX) function. In some implementations, the communication apparatus 110 may further include a memory 114 coupled to processor 112 and capable of being accessed by processor 112 and storing data therein.

In some implementations, the network apparatus 120 may also include a transceiver 126 coupled to processor 122 and capable of wirelessly transmitting and receiving user data, and transmitting the existing PSS/SSS and the LP-WUS to the LP-WUR 118. If the LP-WUR 118 cannot receive the existing PSS/SSS, the transceiver 126 is arranged to transmit the LP-SS to the LP-WUR 118. The transceiver 126 includes a transmitter used to support the TX function and a receiver used to support the RX function. In some implementations, the network apparatus 120 may further include a memory 124 coupled to processor 122 and capable of being accessed by processor 122 and storing data therein.

Accordingly, the communication apparatus 110 and the network apparatus 120 may wirelessly communicate with each other via transceiver 116 and transceiver 126, respectively, and may wirelessly communicate with each other via LP-WUR (which includes no transmitter) 118 and transceiver 126 (particularly, transmitter of the transceiver 126). To aid better understanding, the following description of the operations, functionalities and capabilities of each of communication apparatus 110 and network apparatus 120 is provided in the context of a mobile communication environment in which communication apparatus 110 is implemented in or as a communication apparatus or a UE, and network apparatus 120 is implemented in or as a network node or a base station (e.g., gNB) of a communication network.

In some embodiments of the present invention, a harmonized design that accommodates OOK-1/OOK-4 and OFDM waveform (i.e., specified overlaid OFDM sequences over OOK symbol) can be employed. For RRC IDLE/INACTIVE, in addition to existing PSS/SSS, LP-SS (i.e., OOK-1 and/or OOK-4 waveform with/without overlaid OFDM sequences) for LP-WUR that cannot receive existing PSS/SSS, can be supported for synchronization and/or RRM for serving cell.

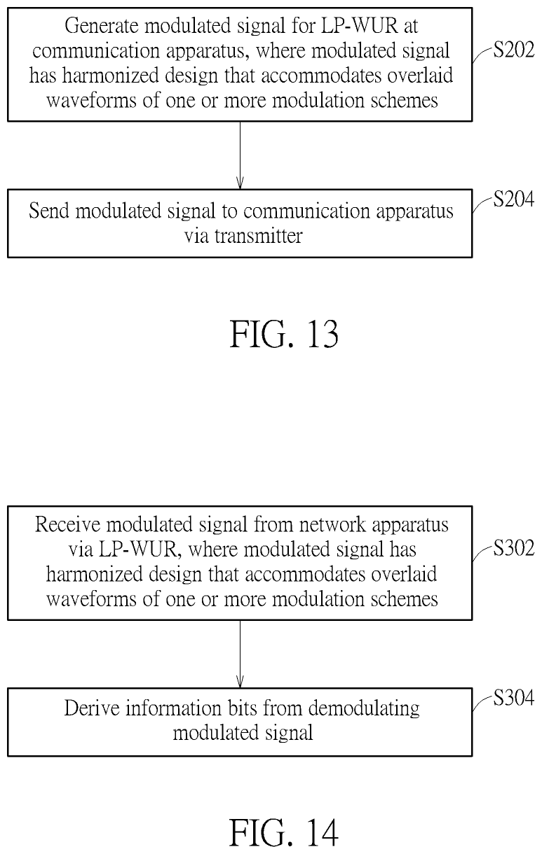

Please refer to FIG. 12 in conjunction with FIG. 13. FIG. 13 is a flowchart illustrating operations performed by the network apparatus (e.g., gNB) 120 for generating and sending a modulated signal S MOD with a harmonized design according to an embodiment of the present invention. The processor 122 is configured to send signals to the communication apparatus (e.g., UE) 110 via the transceiver 126 (particularly, transmitter of transceiver 126). At step S202, the processor 122 generates the modulated signal S MOD for the LP-WUR 118 at the communication apparatus 110. At step S204, the processor 122 sends the modulated signal S MOD to the communication apparatus 110 via the transmitter 126.

Please refer to FIG. 12 in conjunction with FIG. 14. FIG. 14 is a flowchart illustrating operations performed by the communication apparatus (e.g., UE) 110 for receiving and demodulating a modulated signal S MOD with a harmonized design according to an embodiment of the present invention. The processor 112 is configured to receive signals from the network apparatus (e.g., gNB) 120 via the transceiver 116 or the LP-WUR 118. At step S302, the processor 112 receives the modulated signal S MOD from the network apparatus (e.g., gNB) via the LP-WUR 118. At step S304, the processor 112 derives information bits from demodulating the modulated signal S MOD.

The modulated signal S MOD sent from transceiver 126 of network apparatus (e.g., gNB) 120 and received by LP-WUR 118 of communication apparatus (e.g., UE) 110 has a harmonized design that accommodates overlaid waveforms of one or more modulation schemes. For example, the modulated signal S MOD may be a low power wakeup signal (LP-WUS). For another example, the modulated signal S MOD may be an LP-WUR synchronization signal (LP-SS) for LP-WUR 118 that cannot receive existing PSS/SSS.

In some embodiments of the present invention, the harmonized design may accommodate overlaid waveforms of different modulation schemes. For example, the different modulation schemes may include an on-off keying (OOK) based modulation and a non-OOK based modulation. The OOK-based modulation may include one of OOK-1 and OOK-4. In a case where the non-OOK based modulation is an orthogonal frequency division multiplexing (OFDM) based modulation, transmission of the modulated signal S MOD may have the waveform as illustrated in FIG. 7. Specifically, the modulated signal S MOD may have a plurality of signal segments with waveforms and a plurality of signal segments with no waveforms, where the waveforms are generated based on OFDM modulation. When OOK demodulation is applied to the modulated signal S MOD, the signal segments with waveforms and the signal segments with no waveforms can be decoded to obtain OOK bits (which are information bits sent from the network apparatus 120 to the communication apparatus 110). When the OFDM demodulation is applied to the modulated signal S MOD, the signal segments with waveforms can be decoded to obtain OFDM bits (which are information bits sent from the network apparatus 120 to the communication apparatus 110). However, this is for illustrative purposes only, and is not meant to be a limitation of the present invention. For example, the different modulation schemes may include an OFDM-based modulation and any non-OFDM based modulation.

It should be noted that the modulated signal S MOD sent from the network apparatus (e.g., gNB) 120 to the communication apparatus (e.g., UE) 110 is allowed to be an OOK-only signal or an OFDM-only signal, depending upon actual design requirements. For better comprehension of technical features of the present invention, the following assumes that the harmonized design accommodates overlaid waveforms of different modulation schemes (e.g., OOK and OFDM).

Same information bits may be carried by each of the overlaid waveforms of the different modulation schemes (e.g., OOK and OFDM). Consider a case where the communication apparatus 110 is equipped with non-OOK demodulation capability (e.g., OFDM demodulation capability), non-OOK based modulation (e.g., OFDM modulation) is decodable at the communication apparatus 110. Hence, the processor 112 of the communication apparatus 110 can derive information bits from the modulated signal S MOD by applying non-OOK demodulation (e.g., OFDM demodulation) to the modulated signal S MOD. Consider another case wherein the communication apparatus (e.g., UE) 110 is equipped with OOK demodulation capability and is not equipped with non-OOK demodulation (e.g., capability OFDM demodulation capability), non-OOK based modulation (e.g., OFDM modulation) is not decodable at the communication apparatus 110. Hence, the processor 112 of the communication apparatus 110 can derive the same information bits from the modulated signal S MOD by applying OOK demodulation to the modulated signal S MOD.

To put it simply, a modulated signal having a harmonized design that accommodates overlaid waveforms of different modulation schemes allows information bits to be decodable at one communication apparatus that supports decoding of one modulation scheme, and also allows the same information bits to be decodable at another communication apparatus that supports decoding of another modulation scheme.

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication apparatus comprising:
a low power wakeup receiver (LP-WUR); and
a processor, configured to perform operations comprising:
receiving a modulated signal from a network apparatus via the LP-WUR, wherein the modulated signal has a harmonized design that accommodates overlaid waveforms of one or more modulation schemes; and
deriving information bits from demodulating the modulated signal.

2. The communication apparatus of claim 1, wherein the harmonized design accommodates the overlaid waveforms of different modulation schemes, and same information bits are carried by each of the overlaid waveforms of different modulation schemes.

3. The communication apparatus of claim 1, wherein the harmonized design accommodates the overlaid waveforms of different modulation schemes, and the different modulation schemes comprise an on-off keying (OOK) based modulation.

4. The communication apparatus of claim 3, wherein the OOK based modulation includes one of OOK-1 and OOK-4.

5. The communication apparatus of claim 3, wherein the different modulation schemes further comprise a non-OOK based modulation that is not decodable at the communication apparatus, and deriving the information bits from demodulating the modulated signal comprises:
applying OOK based demodulation to the modulated signal.

6. The communication apparatus of claim 5, wherein the non-OOK based modulation is an orthogonal frequency division multiplexing (OFDM) based modulation.

7. The communication apparatus of claim 1, wherein the harmonized design accommodates the overlaid waveforms of different modulation schemes, and the different modulation schemes comprise an orthogonal frequency division multiplexing (OFDM) based modulation.

8. The communication apparatus of claim 1, wherein the modulated signal is one of a low power wakeup signal (LP-WUS) and an LP-WUR synchronization signal (LP-SS).

9. A communication method comprising:
receiving a modulated signal from a network apparatus via a low power wakeup receiver (LP-WUR), wherein the modulated signal has a harmonized design that accommodates overlaid waveforms of one or more modulation schemes; and
deriving information bits from demodulating the modulated signal.

10. The communication method of claim 9, wherein the harmonized design accommodates the overlaid waveforms of different modulation schemes, and same information bits are carried by each of the overlaid waveforms of different modulation schemes.

11. The communication method of claim 9, wherein the harmonized design accommodates the overlaid waveforms of different modulation schemes, and the different modulation schemes comprise an on-off keying (OOK) based modulation.

12. The communication method of claim 11, wherein the different modulation schemes further comprise a non-OOK based modulation that is not decodable at the communication apparatus, and deriving the information bits from demodulating the modulated signal comprises:
applying OOK based demodulation to the modulated signal.

13. The communication method of claim 12, wherein the non-OOK based modulation is an orthogonal frequency division multiplexing (OFDM) based modulation.

14. The communication method of claim 9, wherein the harmonized design accommodates the overlaid waveforms of different modulation schemes, and the different modulation schemes comprise an orthogonal frequency division multiplexing (OFDM) based modulation.

15. The communication method of claim 9, wherein the modulated signal is a low power wakeup signal (LP-WUS).

16. The communication method of claim 9, wherein the modulated signal is an LP-WUR synchronization signal (LP-SS).

17. A network apparatus comprising:
a transmitter; and
a processor, configured to perform operations comprising:
generating a modulated signal for a low power wakeup receiver (LP-WUR) at a communication apparatus, wherein the modulated signal has a harmonized design that accommodates overlaid waveforms of one or more modulation schemes; and
sending the modulated signal to the communication apparatus via the transmitter.

18. The network apparatus of claim 17, wherein the harmonized design accommodates the overlaid waveforms of different modulation schemes, and same information bits are carried by each of the overlaid waveforms of different modulation schemes.

19. The network apparatus of claim 17, wherein the harmonized design accommodates the overlaid waveforms of different modulation schemes, and the different modulation schemes comprise at least one of an on-off keying (OOK) based modulation and an orthogonal frequency division multiplexing (OFDM) based modulation.

20. The network apparatus of claim 17, wherein the modulated signal is one of a low power wakeup signal (LP-WUS) and an LP-WUR synchronization signal (LP-SS).
